(19) United States
(12) Patent Application Publication
(10) Pub. No.: US 2005/0285878 A1
(43) Pub. Date: Dec. 29, 2005

(54) Mobile platform

(76) Inventors: Siddharth Singh, Singapore (SG); Adrian David Cheok, Singapore (SG); Guo Loong Ng, Singapore (SG)

Correspondence Address: CHRISTIE, PARKER & HALE, LLP, PO BOX 7068, PASADENA, CA, 91109-7068, US

(21) Appl. No.: 10/857,048

(22) Filed: May 28, 2004

(51) Int. Cl. H04B 7/00

(52) U.S. Cl. 345/633

(57) ABSTRACT

A mobile platform for providing a mixed reality experience to a user via a mobile communications device of the user, the platform including an image capturing module to capture images of an item in a first scene, the item having at least one marker; a communications module to transmit the captured images to a server, and to receive images in a second scene from the server providing a mixed reality experience to the user. In addition, the second scene is generated by retrieving multimedia content associated with an identified marker, and superimposing the associated multimedia content over the first scene in a relative position to the identified marker.

### CROSS REFERENCE TO RELATED APPLICATIONS

This application is related to the following applications filed May 28, 2004: (1) Application entitled MARKETING PLATFORM, having Attorney Docket No. 52653/DJB/N334; (2) Application entitled A GAME, having Attorney Docket No. 52654/DJB/N334; (3) Application entitled AN INTERACTIVE SYSTEM AND METHOD, having Attorney Docket No. 52655/DJB/N334; and (4) Application entitled AN INTERACTIVE SYSTEM AND METHOD, having Attorney Docket No. 52656/DJB/N334. The contents of these four related applications are expressly incorporated herein by reference as if set forth in full.

### TECHNICAL FIELD

The invention concerns a mobile platform for providing a mixed reality experience to a user via a mobile communications device of the user.

### BACKGROUND OF THE INVENTION

Mixed reality is experienced mainly through Head Mounted Displays (HMDs). HMDs are expensive which prevents widespread usage of mixed reality applications in the consumer market. Also, HMDs are obtrusive and heavy and therefore cannot be worn or carried by users all the time.

### SUMMARY OF THE INVENTION

In a first preferred aspect, there is provided a mobile platform for providing a mixed reality experience to a user via a mobile communications device of the user, the platform including an image capturing module to capture images of an item in a first scene, the item having at least one marker and a communications module to transmit the captured images to a server, and to receive images in a second scene from the server providing a mixed reality experience to the user. In addition, the second scene is generated by retrieving multimedia content associated with an identified marker, and superimposing the associated multimedia content over the first scene in a relative position to the identified marker.

The mobile communications device may be a mobile phone, Personal Digital Assistant (PDA) or a PDA phone.

The images may be captured as still images or images which form a video stream.

The item may be a three dimensional object.

In several embodiments, at least two surfaces of the object are substantially planar. Preferably, the at least two surfaces are joined together.

The object may be a cube or polyhedron.

The communications module may communicate with the server via Bluetooth, 3G, GPRS, Wi-Fi IEEE 802.11b, WiMax, ZigBee, Ultrawideband, Mobile-Fi or other wireless protocol. Images may be communicated as data packets between the mobile communications device and the server.

The image capturing module may comprise an image adjusting tool to enable users to change the brightness, contrast and image resolution for capturing an image.

In a second aspect, there is provided a mobile platform for providing a mixed reality experience to a user via a mobile communications device of the user, the platform including an image capturing module to capture images of an item in a first scene, the item having at least one marker and a graphics module to retrieve multimedia content associated with an identified marker, and generate a second scene including the associated multimedia content superimposed over the first scene in a relative position to the identified marker, to provide a mixed reality experience to the user.

The associated multimedia content may be locally stored on the mobile communications device, or remotely stored on a server.

In a third aspect, there is provided a server for providing a mixed reality experience to a user via a mobile communications device of the user, the server including a communications module to receive captured images of an item in a first scene from the mobile communications device, and to transmit images in a second scene to the mobile communications device providing a mixed reality experience to the user, the item having at least one marker and an image processing module to retrieve multimedia content associated with an identified marker, and to generate the second scene including the associated multimedia content superimposed over the first scene in a relative position to the identified marker.

The server may be mobile, for example, a notebook computer.

In a fourth aspect, there is provided a system for providing a mixed reality experience to a user via a mobile communications device of the user, the system including an item having at least one marker, an image capturing module to capture images of the item in a first scene and an image display module to display images in a second scene providing a mixed reality experience to the user. In addition, the second scene is generated by retrieving multimedia content associated with an identified marker, and superimposing the associated multimedia content over the first scene in a relative position to the identified marker.

In a fifth aspect, there is provided a method for providing a mixed reality experience to a user via a mobile communications device of the user, the method including capturing images of an item having at least one marker, in a first scene and displaying images in a second scene to provide a mixed reality experience to the user. In addition, the second scene is generated by retrieving multimedia content associated with an identified marker, and superimposing the associated multimedia content over the first scene in a relative position to the identified marker.

The associated multimedia content may be virtual objects.

If communication between the mobile communications device and the server is via Bluetooth, a Logical Link Control and Adaptation Protocol (L2CAP) service may be initialized and created. The mobile communications device may discover a server for providing a mixed reality experience to a user by searching for Bluetooth devices within the vicinity of the mobile communications device.

The captured image may be resized to 160×120 pixels. The resized image may be compressed using the JPEG compression algorithm.

In several embodiments, the marker includes a discontinuous border that has a single gap. Advantageously, the gap breaks the symmetry of the border and therefore increases the dissimilarity of the markers.

In further embodiments, the marker comprises an image within the border. The image may be a geometrical pattern to facilitate template matching to identify the marker. The pattern may be matched to an exemplar stored in a repository of exemplars.

In other embodiments, the color of the border produces a high contrast to the background color of the marker, to enable the background to be separated by the server. Advantageously, this lessens the adverse effects of varying lighting conditions.

The marker may be unoccluded to identify the marker.

The marker may be a predetermined shape. To identify the marker, at least a portion of the shape is recognized by the server. The server may determine the complete predetermined shape of the marker using the detected portion of the shape. For example, if the predetermined shape is a square, the server is able to determine that the marker is a square if one corner of the square is occluded.

The server may identify a marker if the border is partially occluded and if the pattern within the border is not occluded.

The system may further comprise a display device such as a monitor, television screen or LCD, to display the second scene at the same time the second scene is generated. The display device may be a view finder of the image capture device or a projector to project images or video. The video frame rate of the display device may be in the range of twelve to thirty per second.

Multimedia content may include 2D or 3D images, video and audio information.

The image capturing module may capture images using a camera. The camera may be CCD or CMOS video camera.

The position of the item may be calculated in three dimensional space A positional relationship may be estimated between the camera and the item.

The camera image may be thresholded. Contiguous dark areas may be identified using a connected components algorithm.

A contour seeking technique may identify the outline of these dark areas. Contours that do not contain four corners may be discarded. Contours that contain an area of the wrong size may be discarded.

Straight lines may be fitted to each side of the square contour. The intersections of the straight lines may be used as estimates of the corner positions.

A projective transformation may be used to warp the region described by these corners to a standard shape. The standard shape may be cross-correlated with stored exemplars of markers to find the marker's identity and orientation.

The positions of the marker corners may be used to identify a unique Euclidean transformation matrix relating to the camera position to the marker position.

In a sixth aspect, there is provided a mixed reality application for delivering messages to a user via a mobile communications device of the user, the application including an item having at least one marker, an image capturing module to capture images of the item in a first scene and an image display module to display images in a second scene providing a mixed reality experience to the user. In addition, the second scene is generated by retrieving a message associated with an identified marker, and superimposing the message over the first scene in a relative position to the identified marker.

The message may be a reminder, e-mail, calendar entry or task to perform.

The item may be magnetic or adhesive, to enable the item to be positioned on a refrigerator door or wall, respectively.

In a seventh aspect, there is provided a mixed reality application for reading via a mobile communications device of a user, the application including a book having at least one marker on each page, an image capturing module to capture images of at least one page in a first scene and an image display module to display images in a second scene providing a mixed reality experience to the user. In addition, the second scene is generated by retrieving multimedia content associated with an identified marker, and superimposing the associated multimedia content over the first scene in a relative position to the identified marker.

### BRIEF DESCRIPTION OF THE DRAWINGS

An example of the invention will now be described with reference to the accompanying drawings, in which:

FIG. 1 is a class diagram showing the abstraction of graphical media and cubes of the interactive system;

FIG. 2 is a table showing the mapping of states and couplings defined in the “method cube” of the interactive system;

FIG. 3 is a table showing inheritance in the interactive system;

FIG. 4 is a table showing the virtual coupling in a 3D Magic Story Cube application;

FIG. 5 is a process flow diagram of the 3D Magic Story Cube application;

FIG. 6 is a table showing the virtual couplings to add furniture in an Interior Design application;

FIG. 7 is a series of screenshots to illustrate how the ‘picking up’ and ‘dropping off’ of virtual objects adds furniture to the board;

FIG. 8 is a series of screenshots to illustrate the method for re-arranging furniture;

FIG. 9 is a table showing the virtual couplings to re-arrange furniture;

FIG. 10 is a series of screenshots to illustrate ‘picking up’ and ‘dropping off’ of virtual objects stacking furniture on the board;

FIG. 11 is a series of screenshots to illustrate throwing out furniture from the board;

FIG. 12 is a series of screenshots to illustrate rearranging furniture collectively;

FIG. 13 is a pictorial representation of the six markers used in the Interior Design application;

FIG. 14 is a class diagram illustrating abstraction and encapsulation of virtual and physical objects;

FIG. 15 is a schematic diagram illustrating the coordinate system of tracking cubes;

FIG. 16 is a process flow diagram of program flow of the Interior Design application;

FIG. 17 is a process flow diagram for adding furniture;

FIG. 18 is a process flow diagram for rearranging furniture;

FIG. 19 is a process flow diagram for deleting furniture;

FIG. 20 depicts a collision of furniture items in the Interior Design application;

FIG. 21 is a block diagram of a gaming system;

FIG. 22 is a system diagram of the modules of the gaming system;

FIG. 23 is a process flow diagram of playing a game;

FIG. 24 is a process flow diagram of the game thread and network thread of the networking module;

FIG. 25 depicts the world and viewing coordinate systems;

FIG. 26 depicts the viewing coordinate system;

FIG. 27 depicts the final orientation of the viewing coordinate system;

FIG. 28 is a table of the elements in the structure of a cube;

FIG. 29 is a process flow diagram of the game logic for the game module;

FIG. 30 is a table of the elements in the structure of a player;

FIG. 31 is a screenshot of the mobile phone augmented reality system in use;

FIG. 32 is a process flow diagram of the tasks performed in the mobile phone augmented reality system;

FIG. 33 is a block diagram of the mobile phone augmented reality system;

FIG. 34 is system component diagram of the mobile phone augmented reality system;

FIG. 35 is a screenshot of two mobile phones displaying virtual objects;

FIG. 36 is a process flow diagram of the mobile phone capturing an image and transmitting it to the AR server module;

FIG. 37 is a process flow diagram of the mobile phone receiving an image from the AR server module and displaying it on the mobile phone screen;

FIG. 38 is a process flow diagram of the MXR Toolkit;

FIG. 39 is a process flow diagram of the mobile phone capturing an image and transmitting it to the AR server module;

FIG. 40 is an illustration of two markers used in the system;

FIG. 41 depicts the relationship between marker coordinates and the camera coordinates estimated by image analysis;

FIG. 42 depicts two perpendicular unit direction vectors calculated from u1 and u2;

FIG. 43 depicts the translation of point p to p′;

FIG. 44 depicts point p scaled by a factor of sx in the x-direction;

FIG. 45 depicts rotation of a point by θ about the origin in a 2D plane;

FIG. 46 is a screenshot of an AR image on a mobile phone;

FIG. 47 is a screenshot of the MXR application with different virtual objects overlaid on different markers;

FIG. 48 is a screenshot of the MXR application with multiple virtual objects displayed at the same time;

FIG. 49 is a screenshot of the MXR application with different virtual objects overlaid for the same marker; and

FIG. 50 is a series of screenshots of the MXR application displaying virtual objects.

### DETAILED DESCRIPTION OF THE DRAWINGS

The drawings and the following discussion are intended to provide a brief, general description of a suitable computing environment in which the present invention may be implemented. Although not required, the invention will be described in the general context of computer-executable instructions, such as program modules, being executed by a personal computer. Generally, program modules include routines, programs, characters, components, data structures, that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

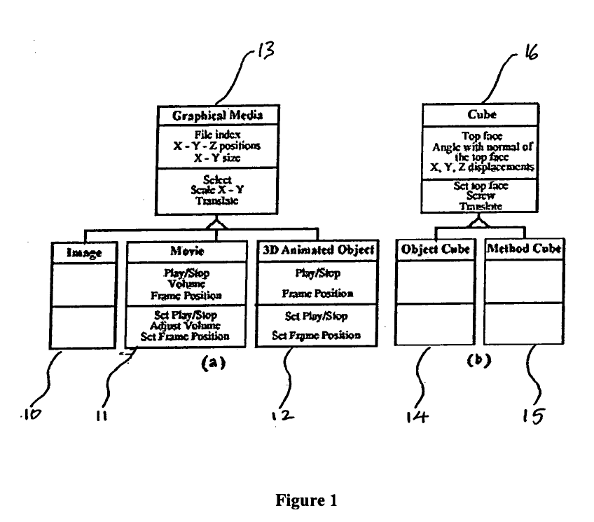

Referring to FIG. 1, an interactive system is provided to allow interaction with a software application on a computer. In this example, the software application is a media player application for playing media files. Media files include AVI movie files or WAV audio files. The interactive system comprises software programmed using Visual C++ 6.0 on the Microsoft Windows 2000 platform, a computer monitor, and a Dragonfly Camera mounted above the monitor to track the desktop area.

Complex interactions using a simple Tangible User Interface (TUI) are enabled by applying Object Oriented Tangible User Interface (OOTUI) concepts to software development for the interactive system. The attributes and methods from objects of different classes are abstracted using Object Oriented Programming (OOP) techniques. FIG. 1 at (a), shows the virtual objects (Image 10, Movie 11, 3D Animated Object 12) structured in a hierarchical manner with their commonalities classified under the super class, Graphical Media 13. The three subclasses that correspond to the virtual objects are Image 10, Movie 11 and 3D Animated Object 12. These subclasses inherit attributes and methods from the Graphical Media super class 13. The Movie 11 and 3D Animated Object 12 subclasses contain attributes and methods that are unique to their own class. These attributes and methods are coupled with physical properties and actions of the TUI decided by the state of the TUI. Related audio information can be associated with the graphical media 11, 12, 13, such as sound effects. In the system, the TUI allows control of activities including searching a database of files and sizing, scaling and moving of graphical media 11, 12, 13. For movies and 3D objects 11, 12, activities include playing/pausing, fast-forwarding and rewinding media files. Also, the sound volume is adjustable.

In this example, the TUI is a cube. A cube in contrast to a ball or complex shapes, has stable physical equilibriums on one of its surfaces making it relatively easier to track or sense. In this system, the states of the cube are defined by these physical equilibriums. Also, cubes can be piled on top of one another. When piled, the cubes form a compact and stable physical structure. This reduces scatter on the interactive workspace. Cubes are intuitive and simple objects familiar to most people since childhood. A cube can be grasped which allows people to take advantage of keen spatial reasoning and leverages off prehensile behaviours for physical object manipulations.

The position and movement of the cubes are detected using a vision-based tracking algorithm to manipulate graphical media via the media player application. Six different markers are present on the cube, one marker per surface. In other instances, more than one marker can be placed on a surface. The position of each marker relative to each another is known and fixed because the relationship of the surfaces of the cube is known. To identify the position of the cube, any one of the six markers is tracked. This ensures continuous tracking even when a hand or both hands occlude different parts of the cube during interaction. This means that the cubes can be intuitively and directly handled with minimal constraints on the ability to manipulate the cube.

The state of artefact is used to switch the coupling relationship with the classes. The states of each cube are defined from the six physical equilibriums of a cube, when the cube is resting on any one of its faces. For interacting with the media player application, only three classes need to be dealt with. A single cube provides adequate couplings with the three classes, as a cube has six states. This cube is referred to as an “Object Cube” 14.

However, for handling the virtual attributes/methods 17 of a virtual object, a single cube is insufficient as the maximum number of couplings has already reached six, for the Movie 11 and 3D Animated object 12 classes. The total number of couplings is six states of a cube<3 classes+6 attributes/methods 17. This exceeds the limit for a single cube. Therefore, a second cube is provided for coupling the virtual attribute/methods 17 of a virtual object. This cube is referred to as a “Method Cube” 15.

The state of the “Object Cube” 14 decides the class of object displayed and the class with which the “Method Cube” 15 is coupled. The state of the “Method Cube” 15 decides which virtual attribute/method 17 the physical property/action 18 is coupled with. Relevant information is structured and categorized for the virtual objects and also for the cubes. FIG. 1, at (b) shows the structure of the cube 16 after abstraction.

The “Object Cube” 14 serves as a database housing graphical media. There are three valid states of the cube. When the top face of the cube is tracked and corresponds to one of the three pre-defined markers, it only allows displaying the instance of the class it has inherited from, that is the type of media file in this example. When the cube is rotated or translated, the graphical virtual object is displayed as though it was attached on the top face of the cube. It is also possible to introduce some elasticity for the attachment between the virtual object and physical cube. These states of the cube also decide the coupled class of “Method Cube” 15, activating or deactivating the couplings to the actions according to the inherited class.

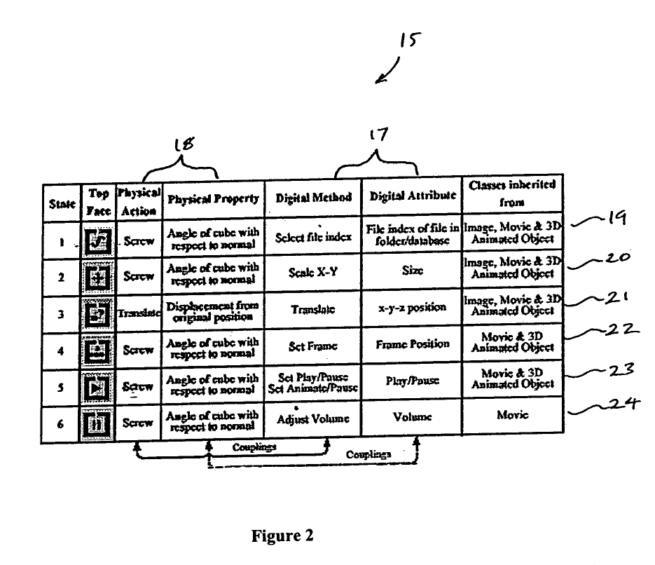

Referring to FIG. 2, on the ‘Method Cube’ 15, the properties/actions 18 of the cube are respectively mapped to the attributes/methods 17 of the three classes of the virtual object. Although there are three different classes of virtual object which have different attributes and methods, new interfaces do not have to be designed for all of them. Instead, redundancy is reduced by grouping similar methods/properties and implementing the similar methods/properties using the same interface.

In FIG. 2, methods ‘Select’ 19, ‘Scale X-Y’ 20 and ‘Translate’ 21 are inherited from the Graphical Media super-class 13. They can be grouped together for control by the same interface. Methods ‘Set Play/Stop’ 23, ‘Set Animate/Stop’, ‘Adjust Volume’ 24 and ‘Set Frame Position’ 22 are methods exclusive to the individual classes and differ in implementation. Although the methods 17 differ in implementation, methods 17 encompassing a similar idea or concept can still be grouped under one interface. As shown, only one set of physical property/action 18 is used to couple with the ‘Scale’ method 20 which all three classes have in common. This is an implementation of polymorphism in OOTUI. This is a compact and efficient way of creating TUIs by preventing duplication of interfaces or information across classifiable classes and the number of interfaces in the system is reduced. Using this methodology, the number of interfaces is reduced from fifteen (methods for image—three interfaces, movie—six interfaces, 3D object—six interfaces) to six interfaces. This allows the system to be handled by six states of a single cube.

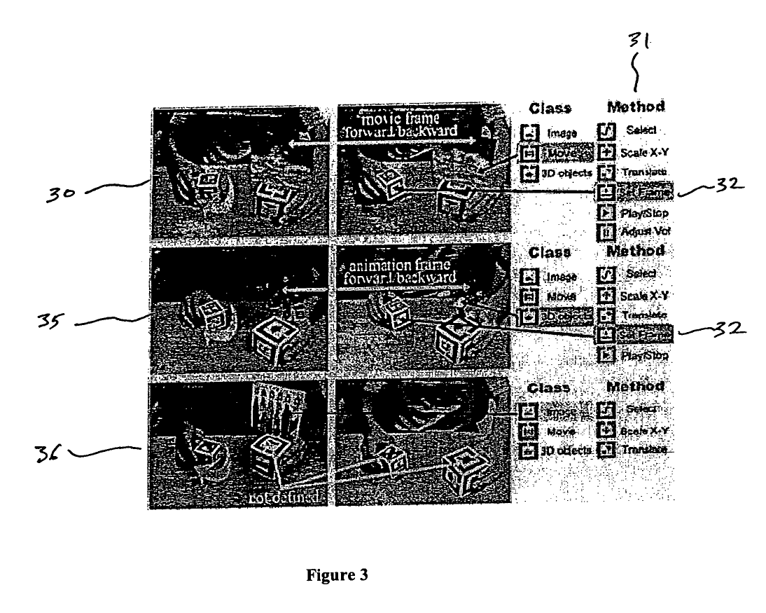

Referring to FIG. 3, the first row of pictures 30 shows that the cubes inherit properties for coupling with methods 31 from ‘movie’ class 11. The user is able to toggle through the scenes using the ‘Set Frame Method’ 32 which is in the inherited class. The second row 35 shows the user doing the same task for the ‘3D object’ class 12. The first picture in the third row 36 shows that ‘image’ class 10 does not inherit the ‘Set Frame Method’ 32 hence a red cross appears on the surface. The second picture shows that the ‘Object Cube’ 14 is in an undefined state indicated by a red cross.

The rotating action of the ‘Method Cube’ 15 to the ‘Set Frame’ 32 method of the movie 11 and animated object 12 is an intuitive interface for watching movies. This method indirectly fulfils functions on a typical video-player such as ‘fast-forward’ and ‘rewind’. Also, the ‘Method Cube’ 15 allows users to ‘play/pause’ the animation.

The user can size graphical media of all the three classes by the same action, that is, by rotating the ‘Method Cube’ 15 with “+” as the top face (state 2). This invokes the ‘Size’ method 20 which changes the size of the graphical media with reference to the angle of the cube to the normal of its top face. From the perspective of a designer of TUIs, the ‘Size’ method 20 is implemented differently for the three classes 10, 11,12. However, this difference in implementation is not perceived by the user and is transparent.

To enhance the audio and visual experience for the users, visual and audio effects are added to create an emotionally evocative experience. For example, an animated green circular arrow and a red cross are used to indicate available actions. Audio feedback include a sound effect to indicate state changes for both the object and method cubes.

### EXAMPLE

### 3D Magic Story Cube Application

Another application of the interactive system is the 3D Magic Story Cube application. In this application, the story cube tells a famous Bible story, “Noah's Ark”. Hardware required by the application includes a computer, a camera and a foldable cube. Minimum requirements for the computer are at least of 512 MB RAM and a 128 MB graphics card. In one example, an IEEE 1394 camera is used. An IEEE 1394 card is installed in the computer to interface with the IEEE 1394 camera. Two suitable IEEE 1394 cameras for this application are the Dragonfly cameras or the Firefly cameras manufactured by Point Grey Research Inc. of Vancouver, Canada. Both of these cameras are able to grab color images at a resolution of 640×480 pixels, at a speed of 30 Hz. This is able to view the 3D version of the story whilst exploring the folding tangible cube. The higher the capture speed of the camera is, the more realistic the mixed reality experience is to the user due to a reduction in latency. The higher the resolution of the camera, the greater the image detail. A foldable cube is used as the TUI for 3D storytelling. Users can unfold the cube in a unilateral manner. Foldable cubes have previously been used for 2D storytelling with the pictures printed out on the cube's surfaces.

The software and software libraries used in this application are Microsoft Visual C++ 6.0, OpenGL, GLUT and MXR Development toolkit manufactured by Microsoft Corporation of Redmond, Wash. Microsoft Visual C++ 6.0 is used as the development tool. It features a fully integrated editor, compiler, and debugger to make coding and software development easier. Libraries for other components are also integrated. In Virtual Reality (VR) mode, OpenGL and GLUT play important roles for graphics display. OpenGL is the premier environment for developing portable, interactive 2D and 3D graphics applications. OpenGL is responsible for all the manipulation of the graphics in 2D and 3D in VR mode. GLUT is the OpenGL Utility Toolkit and is a window system independent toolkit for writing OpenGL programs. It is used to implement a windowing application programming interface (API) for OpenGL. The MXR Development Toolkit enables developers to create Augmented Reality (AR) software applications. It is used for programming the applications mainly in video capturing and marker recognition. The MXR Toolkit is a computer vision tool to track fiducials and to recognize patterns within the fiducials. The use of a cube with a unique marker on each face allows for the position of the cube to be tracked by the computer by the MXR Toolkit continuously.

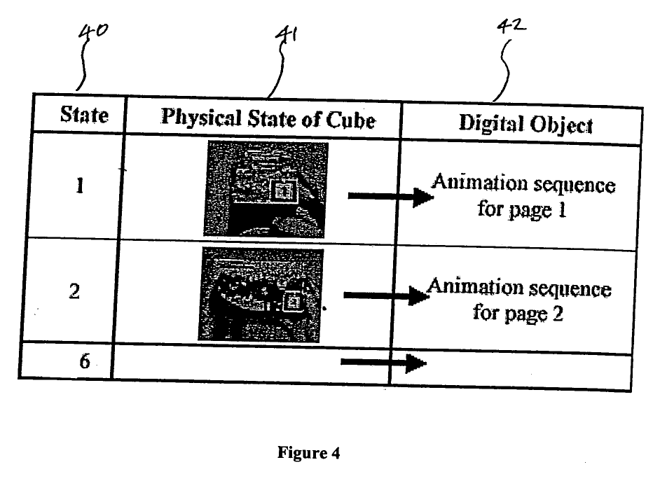

Referring to FIG. 4, the 3D Magic Story Cube application applies a simple state transition model 40 for interactive storytelling. Appropriate segments of audio and 3D animation are played in a pre-defined sequence when the user unfolds the cube into a specific physical state 41. The state transition is, invoked only when the contents of the current state have been played. Applying OOTUI concepts, the virtual coupling of each state of the foldable cube can be mapped 42 to a page of digital animation.

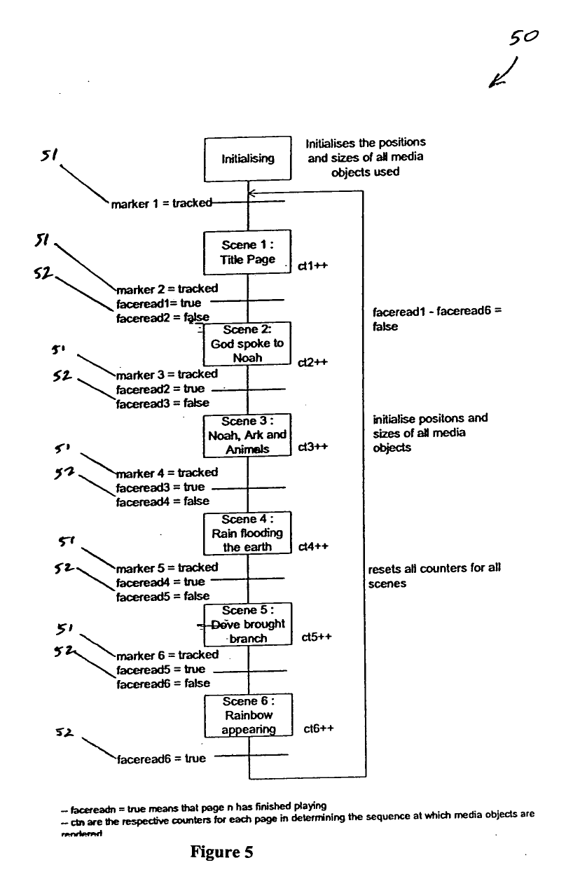

Referring to FIG. 5, an algorithm 50 is designed to track the foldable cube that has a different marker on each unfolded page. The relative position of the markers is tracked 51 and recorded 52. This algorithm ensures continuous tracking and determines when a page has been played once through. This allows the story to be explored in a unidirectional manner allowing the story to maintain a continuous narrative progression. When all the pages of the story have played through once, the user can return to any page of the story to watch the scene play again.

A few design considerations that are kept in mind when designing the system is the robustness of the system during bad lighting conditions and the image resolution.

The unfolding of the cube is unidirectional allowing a new page of the story to be revealed each time the cube is unfolded. Users can view both the story illustrated on the cube in its non-augmented view (2D view) and also in its augmented view (3D view). The scenarios of the story are 3D graphics augmented on the surfaces of the cube.

The AR narrative provides an attractive and understandable experience by introducing 3D graphics and sound in addition to 3D manipulation and 3D sense of touch. The user is able to enjoy a participative and exploratory role in experiencing the story. Physical cubes offer the sense of touch and physical interaction which allows natural and intuitive interaction. Also, the physical cubes allow social storytelling between an audience as they naturally interact with each other.

To enhance user interaction and intuitiveness of unfolding the cube, animated arrows appear to indicate the direction of unfolding the cube after each page or segment of the story is played. Also, the 3D virtual models used have a slight transparency of 96% to ensure that the user's hands are still partially visible to allow for visual feedback on how to manipulate the cube.

The rendering of each page of the story cube is carried out when one particular marker is tracked. As the marker can be large, it is also possible to have multiple markers on one page. Since multiple markers are located on the same surface in a known layout, tracking one of the markers ensures tracking of the other markers. This is a performance issue to facilitate more robust tracking.

To assist with synchronisation, the computer system clock is used to increment the various counters used in the program. This causes the program to run at varying speeds for different computers. An alternative is to use a constant frame rates method in which a constant number of frames are rendered every second. To achieve constant frame rates, one second is divided in many equal sized time slices and the rendering of each frame starts at the beginning of each time slice. The application has to ensure that the rendering of each frame takes no longer than one time slice, otherwise the constant frequency of frames will be broken. To calculate the maximum possible frame rate for the rendering of the 3D Magic Story Cube application, the amount of time needed to render the most complex scene is measured. From this measurement, the number of frames per second is calculated.

### EXAMPLE

### Interior Design Application

A further application developed for the interactive system is the Interior Design application. In this application, the MXR Toolkit is used in conjunction with a furniture board to display the position of the room by using a book as a furniture catalogue.

MXR Toolkit provides the positions of each marker but does not provide information on the commands for interacting with the virtual object. The cubes are graspable allowing the user to have a more representative feel of the virtual object. As the cube is graspable (in contrast to wielding a handle), the freedom of movement is less constrained. The cube is tracked as an object consisting of six joined markers with a known relationship. This ensures continual tracking of the cube even when one marker is occluded or covered.

In addition to cubes, the furniture board has six markers. It possible to use only one marker on the furniture board to obtain a satisfactory level of tracking accuracy. However, using multiple fiducials enables robust tracking so long as one fiducial is not occluded. This is crucial for the continuous tracking of the cube and the board.

To select a particular furniture item, the user uses a furniture catalogue or book with one marker on each page. This concept is similar to the 3D Magic Story Cube application described. The user places the cube in the loading area beside the marker which represents a category of furniture of selection to view the furniture in AR mode.

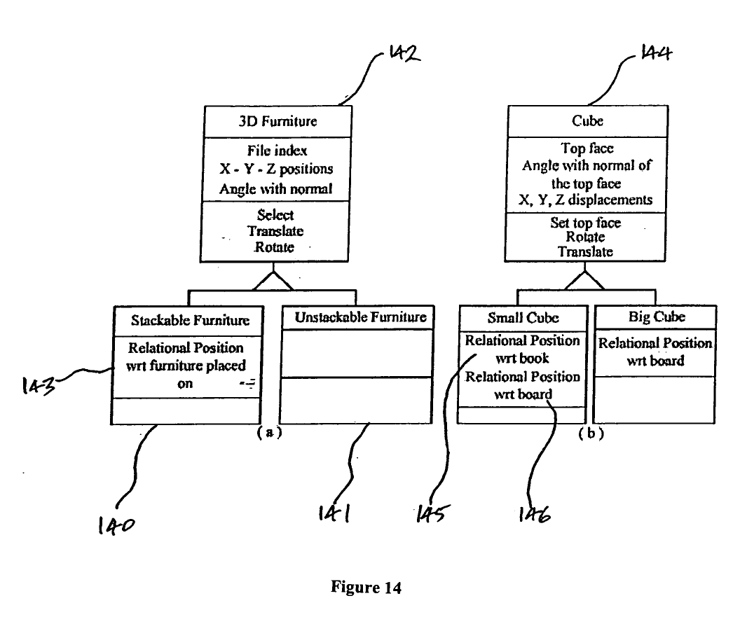

Referring to FIG. 14, prior to determining the tasks to be carried out using cubes, applying OOTUI allows a software developer to deal with complex interfaces. First, the virtual objects of interest and their attributes and methods are determined. The virtual objects are categorized into two groups: stackable objects 140 and unstackable objects 141. Stackable objects 140 are objects that can be placed on top of other objects, such as plants, TVs and Hi-Fi units. They can also be placed on the ground. Both groups 140, 141 inherit attributes and methods from their parent class, 3D Furniture 142. Stackable objects 140 have an extra attribute 143 of its relational position with respect to the object it is placed on. The result of this abstraction is shown in FIG. 14 at (a).

For virtual tool cubes 144, the six equilibriums of the cube are defined as one of the factors determining the states. There are a few additional attributes to this cube to be used in complement with a furniture catalogue and a board. Hence, we have a few additional attributes such as relational position of a cube with respect to the book 145 and board 146. These additional attributes coupled with the attributes inherited from the Cube parent class 144 determines the various states of the cube. This is shown in FIG. 14 at (b).

To pick up an object intuitively, the following is required:
1) Move into close proximity to a desired object
2) Make a ‘picking up’ gesture using the cube

The object being picked up will follow that of the hand until it is dropped. When a real object is dropped, we expect the following:
1) Object starts dropping only when hand makes a dropping gesture
2) In accordance with the laws of gravity, the dropped object falls directly below that of the position of the object before it is dropped
3) If the object is dropped at an angle, it will appear to be at an angle after it is dropped.

These are the underlying principles governing the adding of a virtual object in Augmented Reality.

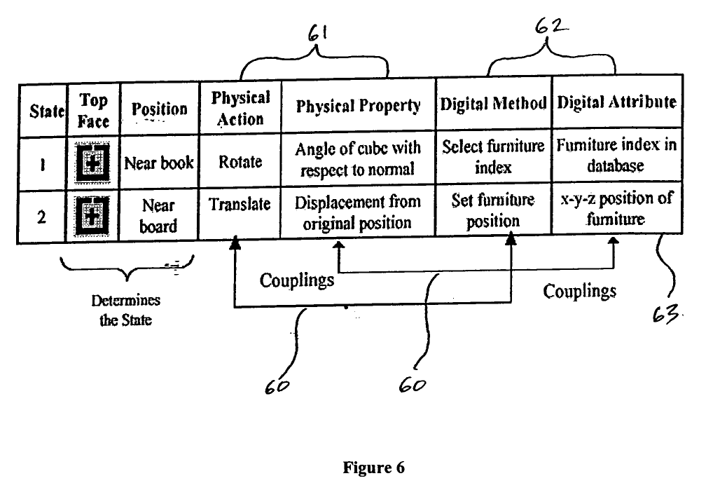

Referring to FIG. 6, applying OOTUI, the couplings 60 are formed between the physical world 61 and virtual world 62 for adding furniture. The concept of translating 63 the cube is used for other methods such as deleting and re-arranging furniture. Similar mappings are made for the other faces of the cube.

To determine the relationship of the cube with respect to the book and the board, the position and proximity of the cubes with respect to the virtual object need to be found. Using the MXR Toolkit, co-ordinates of each marker with respect to the camera is known. Using this information, matrix calculations are performed to find the proximity and relative position of the cube with respect to other passive items including the book and board.

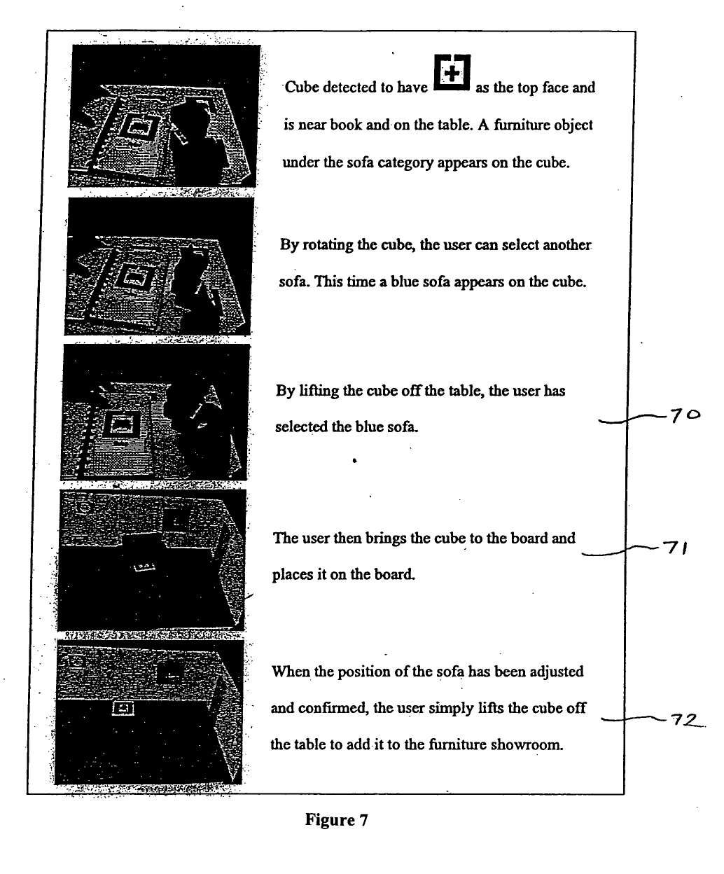

FIG. 7 shows a detailed continuous strip of screenshots to illustrate how the ‘picking up’ 70 and ‘dropping off’ 71 of virtual objects adds furniture 72 to the board.

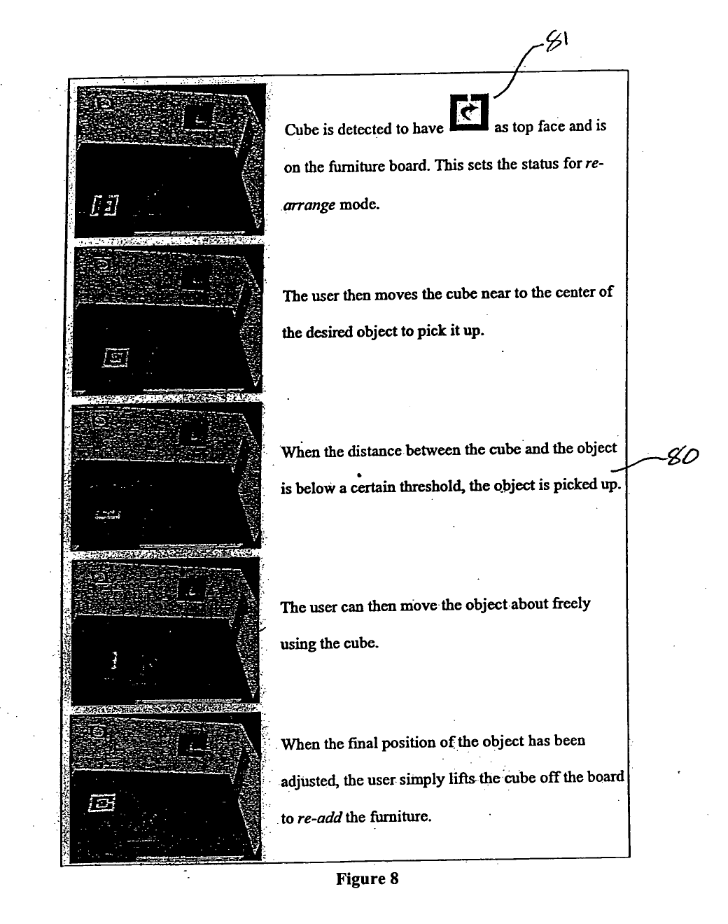

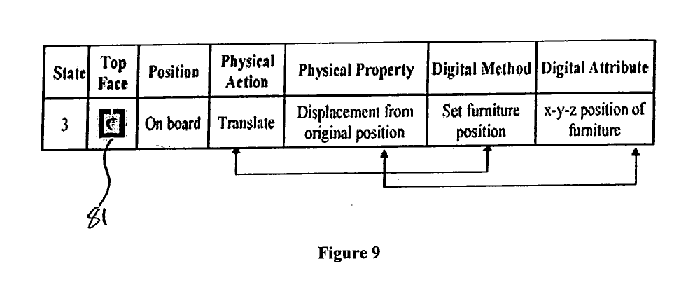

Referring to FIG. 8, similar to adding a furniture item, the idea of ‘picking up’ 80 and dropping off’ is also used for rearranging furniture. The “right turn arrow” marker 81 is used as the top face as it symbolises moving in all directions possible in contrast to the “+” marker which symbolises adding. FIG. 9 shows the virtual couplings to re-arrange furniture.

When designing the AR system, the physical constraints of virtual objects are represented as objects in reality. When introducing furniture in a room, there is a physical constraint when moving the desired virtual furniture in the room. If there is a virtual furniture item already in that position, the user is not allowed to ‘drop off’ another furniture item in that position. The nearest position the user can drop the furniture item is directly adjacent the existing furniture item on board.

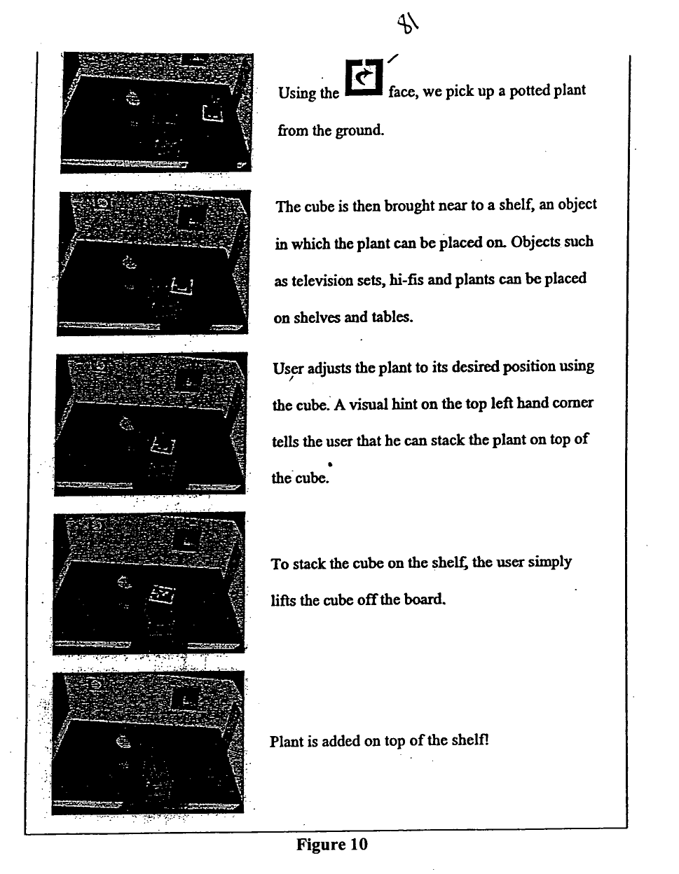

Referring to FIG. 10, a smaller virtual furniture item can be stacked on to larger items. For example, items such as plants and television sets can be placed on top of shelves and tables as well as on the ground. Likewise, items placed on the ground can be re-arranged to be stacked on top of another item. FIG. 10 shows a plant picked up from the ground and placed on the top of a shelf.

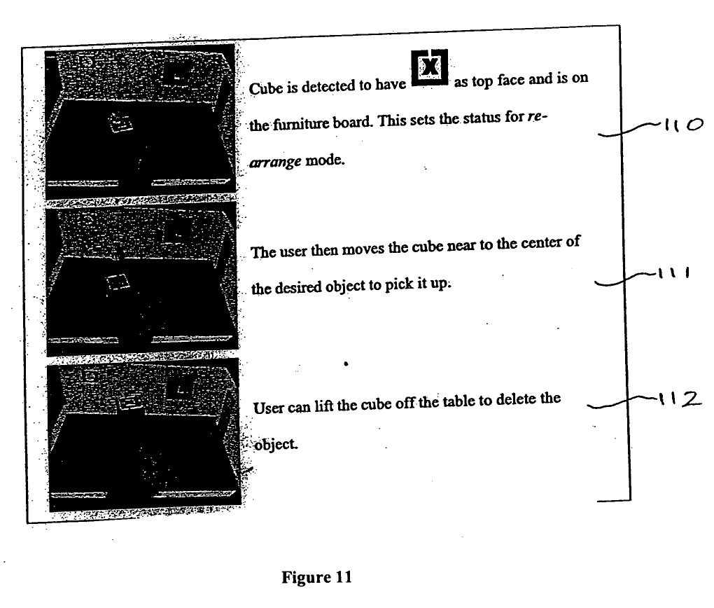

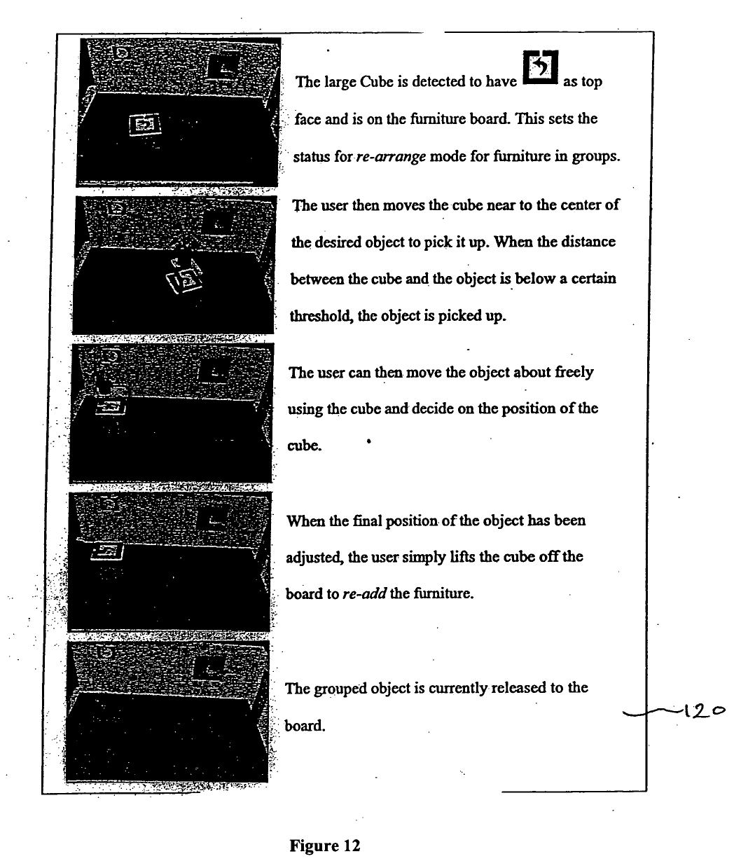

Referring to FIG. 11, to delete or throw out an object intuitively, the following is required:
1) Go to close proximity to desired object 110;
2) Make a ‘picking up’ gesture using the cube 111; and
3) Make a flinging motion with the hand 112;
Referring to FIG. 12, certain furniture items can be stacked on other furniture items. This establishes a grouped and collective relationship 120 with certain virtual objects. FIG. 12 shows the use of the big cube (for grouped objects) in the task of rearranging furniture collectively.

Visual and audio feedback are added to increase intuitiveness for the user. This enhances the user experience and also effectively utilises the user's sense of touch, sound and sight. Various sounds are added when different events take place. These events include selecting a furniture object, picking up, adding, re-arranging and deleting. Also, when a furniture item has collided with another object on the board, an incessant beep is continuously played until the user moves the furniture item to a new position. This makes the augmented tangible user interface more intuitive since providing both visual and audio feedback increases the interaction with the user.

The hardware used in the interior design application includes the furniture board and the cubes. The interior design application extends single marker tracking described earlier. The furniture board is two dimensional whereas the cube is three dimensional for tracking of multiple objects.

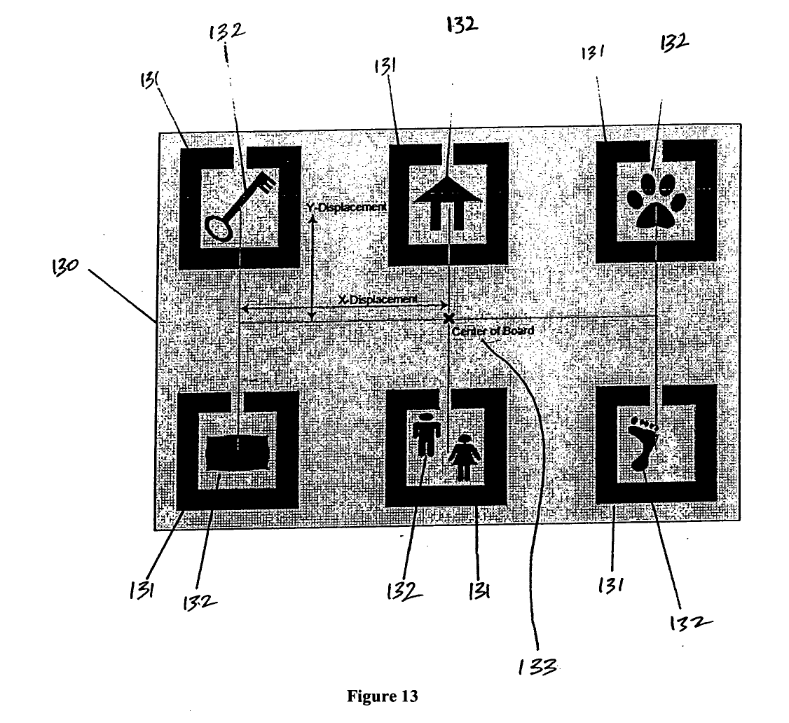

Referring to FIG. 13, the method for tracking user ID cards is extended for tracking the shared whiteboard card 130. Six markers 131 are used to track the position of the board 130 so as to increase robustness of the system. The transformation matrix for multiple markers 131 is estimated from visible markers so errors are introduced when fewer markers are available. Each marker 131 has a unique pattern 132 in its interior that enables the system to identify markers 131, which should be horizontally or vertically aligned and can estimate the board rotation.

The showroom is rendered with respect to the calculated centre 133 of the board. When a specific marker above is being tracked, the centre 133 of the board is calculated using some simple translations using the preset X-displacement and Y-displacement. These calculated centres 133 are then averaged depending on the number of markers 131 tracked. This ensures continuous tracking and rendering of the furniture showroom on the board 130 as long as one marker 131 is being tracked.

When the surface of the marker 131 is approaching parallel to the line of sight, the tracking becomes more difficult. When the marker flips over, the tracking is lost. Since the whole area of the marker 131 must always visible to ensure a successful tracking, it does not allow any occlusions on the marker 131. This leads to the difficulties of manipulation and natural two-handed interaction.

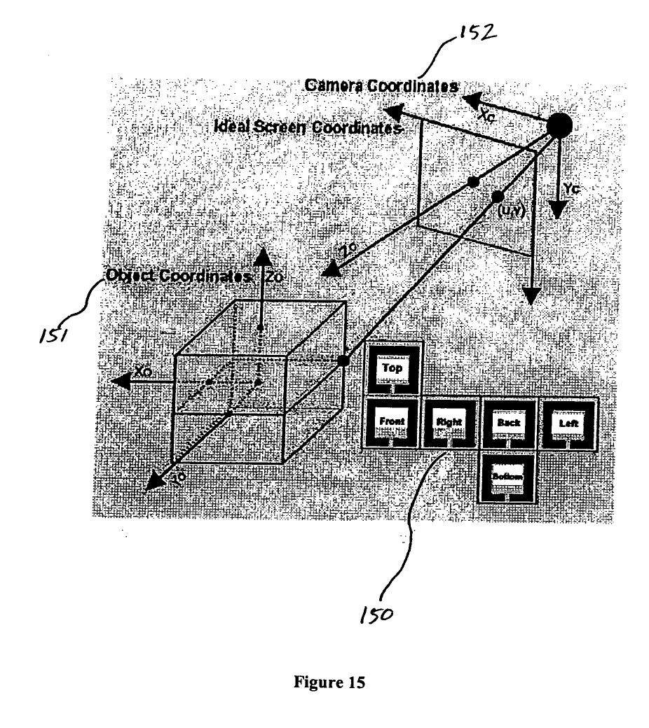

Referring to FIG. 15, one advantage of this algorithm is that it enables direct manipulation of cubes with both hands. When one hand is used to manipulate the cube, the cube is always tracked as long as at least one of the six faces of the cube is detected. The algorithm used to track the cube is as follows:
1. Detect all the surface markers 150 and calculate the corresponding transformation matrix (Tcm) for each detected surface.

2. Choose a surface with the highest tracking confidence and identify its surface ID, that is top, bottom, left, right, front, and back.

3. Calculate the transformation matrix from the marker co-ordinate system to the object co-ordinate system (Tmo) 151 based on the physical relationship of the chosen marker and the cube.

4. The transformation matrix from the object co-ordinate system 151 to the camera co-ordinate system (Tco) 152 is calculated by: Tco=Tcm⁻¹×Tmo.

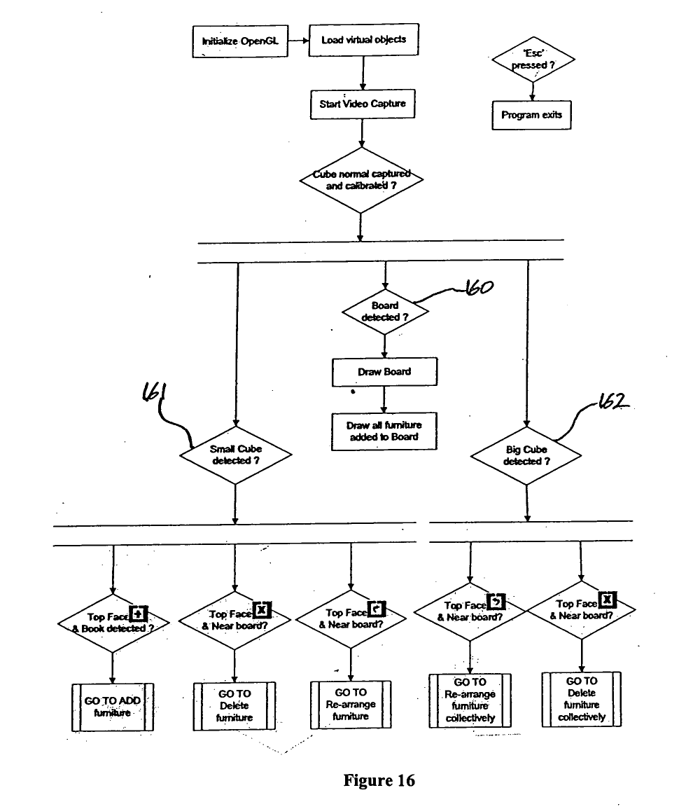

FIG. 16 shows the execution of the AR Interior Design application in which the board 160, small cube 161 and big cube 162 are concurrently being searched for.

To enable the user to pick up a virtual object when the cube is near the marker 131 of the furniture catalogue requires the relative distance between the cube and the virtual object to be known. Since the MXR Toolkit returns the camera co-ordinates of each marker 131, markers are used to calculate distance. Distance between the marker on the cube and the marker for a virtual object is used for finding the proximity of the cube with respect to the marker.

The camera co-ordinates of each marker can be found. This means that the camera co-ordinates of the marker on the cube and that of the marker of the virtual object is provided by the MXR Toolkit. In other words, the co-ordinates of the cube marker with respect to the camera and the co-ordinates of the virtual object marker is known. TA is the transformation matrix to get from the camera origin to the virtual object marker. TB is the transformation matrix to get from the camera origin to the cube marker. However this does not give the relationship between cube marker and virtual object marker. From the co-ordinates, the effective distance can be found.

By finding TA −1, the transformation matrix to get from the virtual object to the camera origin is obtained. Using this information, the relative position of cube with respect to virtual object marker is obtained. The proximity of the cube and the virtual object is of interest only. Hence only the translation needed to get from the virtual object to the cube is required (i.e. Tx, Ty, Tz), and the rotation components can be ignored.

$$[ \begin{matrix}{R}_{11} & {R}_{12} & {R}_{13} & {T}_{x} \\ {R}_{21} & {R}_{22} & {R}_{23} & {T}_{y} \\ {R}_{31} & {R}_{32} & {R}_{33} & {T}_{z} \\ 0 & 0 & 0 & 1\end{matrix} ] = [ {T}_{A}^{- 1} ] [ {T}_{B} ] \qquad ( Equation 6 \text{-} 1 )$$

Tz is used to measure if the cube if it is placed on the book or board. This sets the stage for picking and dropping objects. This value corresponds to the height of the cube with reference to the marker on top of the cube. However, a certain range around the height of the cube is allowed to account for imprecision in tracking.

Tx, Ty is used to determine if the cube is within a certain range of the book or the board. This allows for the cube to be in an ‘adding’ mode if it is near the book and on the loading area. If it is within the perimeter of the board or within a certain radius from the centre of the board, this allows the cube to be re-arranged, deleted, added or stacked onto other objects.

There are a few parameters to determine the state of the cube, which include: the top face of the cube, the height of the cube, and the position of the cube with respect to the board and book.

The system is calibrated by an initialisation step to enable the top face of the cube to be determined during interaction and manipulation of the cube. This step involves capturing the normal of the table before starting when the cube is placed on the table. Thus, the top face of the cube can be determined when it is being manipulated above the table by comparing the normal of the cube and the table top. The transformation matrix of the cube is captured into a matrix called tfmTable. The transformation matrix encompasses all the information about the position and orientation of the marker relative to the camera. In precise terms, it is the Euclidean transformation matrix which transforms points in the frame of reference of the tracking frame, to points in the frame of reference in the camera. The full structure in the program is defined as:

$$[ \begin{matrix}{r}_{11} & {r}_{12} & {r}_{13} & tx \\ {r}_{21} & {r}_{22} & {r}_{23} & ty \\ {r}_{31} & {r}_{32} & {r}_{33} & tz\end{matrix} ]$$

The last row in equation 6-1 is omitted as it does not affect the desired calculations. The first nine elements form a 3×3 rotation matrix and describe the orientation of the object. To determine the top face of the cube, the transformation matrix obtained from tracking each of the face is used and works out the following equation. The transformation matrix for each face of the cube is called tfmCube.
Dot_product=tfmCube.r₁₃*tfmTable.r₁₃+tfmCube.r₂₃*tfmTable.r₂₃+tfmCube.r₃₃*tfmTable.r₃₃ (Equation 6-2)

The face of the cube which produces the largest Dot_product using the transformation matrix in equation 6-2 is determined as the top face of the cube. There are also considerations of where the cube is with respect to the book and board. Four positional states of the cube are defined as—Onboard, Offboard, Onbook and Offbook. The relationship of the states of cube with the position of it, is provided below:

| States of | Height of Cube - | Cube wrt board and book - |
|---|---|---|
| cube | t_{z} | tₓ and t_{y} |
| Onboard | Same as board | Within the boundary of |
| | | board |
| Offboard | Above board | Within the boundary of |
| | | board |
| Onbook | Same as cover of | Near book (furniture |
| | book | catalog) |
| Offbook | Above the cover | Near book (furniture |
| | of book | catalog) |

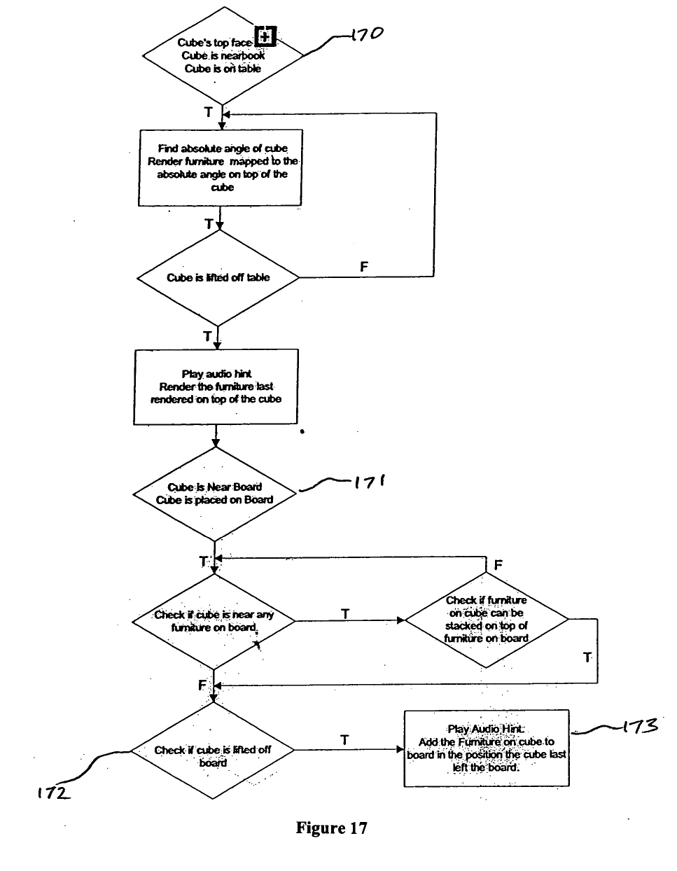

Referring to FIG. 17, adding the furniture is done by using “+” marker as the top face of the cube 170. This is brought near the furniture catalogue with the page of the desired furniture facing up. When the cube is detected to be on the book (Onbook) 171, a virtual furniture object pops up on top of the cube. Using a rotating motion, the user can ‘browse’ through the catalogue as different virtual furniture items pop up on the cube while the cube is being rotated. When the cube is picked up (Offbook), the last virtual furniture item that seen on the cube is picked up 172. When the cube is detected to be on the board (Onboard), the user can add the furniture to the cube by lifting the cube off the board (Offboard) 173. To re-arrange furniture, the cube is placed on the board (Onboard) with the “right arrow” marker as the top face. When the cube is detected as placed on the board, the user can ‘pick up’ the furniture by moving the cube to the centre of the desired furniture.

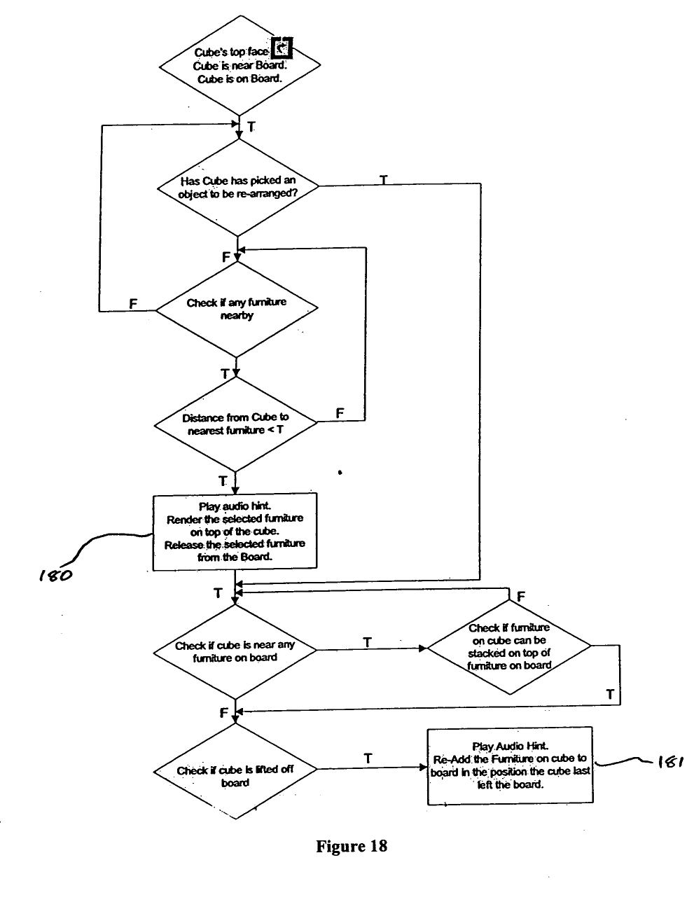

Referring to FIG. 18, when the furniture is being ‘picked up’ (Offboard), the furniture is rendered on top of the cube and an audio hint is sounded 180. The user then moves the cube on the board to a desired position. When the position is selected, the user simply lifts the cube off the board to drop it into that position 181.

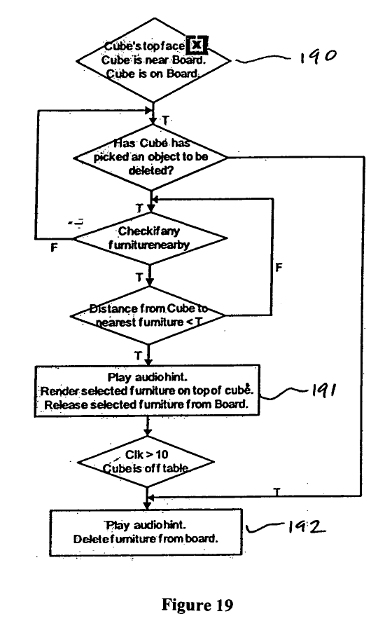

Referring to FIG. 19, to delete furniture, the cube is placed on the board (Onboard) with the “x” marker as the top face 190. When the cube is being detected to be on the board, the user can select the furniture by moving the cube to the centre of the desired furniture. When the furniture is successfully selected, the furniture is rendered on top of the cube and an audio hint is sounded 191. The user then lifts the cube off the board (Offboard) to delete the furniture 192.

When a furniture is being introduced or re-arranged, a problem to keep in mind is the physical constraints of the furniture. Similar to reality, furniture in an Augmented Reality world cannot collide with or ‘intersect’ with another. Hence, users are not allowed to add furniture when it collides with another.

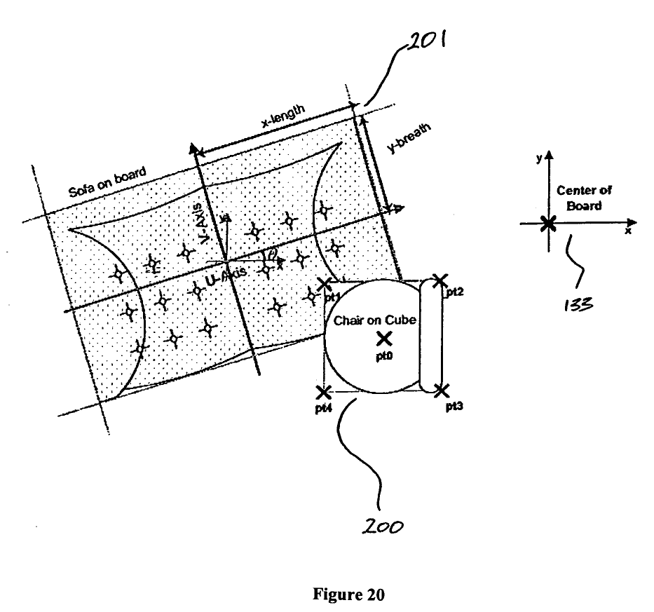

Referring to FIG. 20, one way to solve the problem of furniture items colliding is to transpose the four bounding co-ordinates 200 and the centre of the furniture being added to the co-ordinates system of the furniture which is being collided with. The points pt0, pt1, pt2, pt3, pt4 200 are transposed to the U-V axis of the furniture on board. The U-V co-ordinates of these five points are then checked against the x-length and y-breadth of the furniture on board 201.
U_{N}=cos θ(X_{N}−Xₒ)+sin θ(Y_{N}−Yₒ)
V_{N}=sin θ(X_{N}−Xₒ)+cos θ(Y_{N}−Yₒ)

Where

| | |
|---|---|
| (U_{N}, V_{N}) | New transposed coordinates with respect to |
| | the furniture on board |
| θ | Angle furniture on board makes with respect |
| | to X-Y coordinates |
| (Xₒ, Yₒ) | X-Y Center coordinates of furniture on board |
| (X_{N}, Y_{N}) | Any X-Y coordinates of furniture on cube |
| | (from figure --, they represent pt0, pt1, |
| | pt2, pt3, pt4) |

Only if any of the U-V co-ordinates fulfil UN<x-length && VN<y-breadth will the audio effect sound. This indicates to the user that they are not allowed to drop the furniture item at the position and must move to another position before dropping the furniture item.

For furniture such as tables and shelves in which things can be stacked on top of them, a flag is provided in their furniture structure called stacked. This flag is set true when an object such as a plant, hi-fi unit or TV is detected for release on top of this object. This category of objects allows up to four objects placed on them. This type of furniture, for example, a plant, then stores the relative transformation matrix of the stacked object to the table or shelf in its structure in addition to the relative matrix to the centre of the board. When the camera has detected top face “left arrow” or “x” of the big cube, it goes into the mode of re-arranging and deleting objects collectively. Thus, if a table or shelf is to be picked, and if stacked flag is true, then, the objects on top of the table or shelf can be rendered according on the cube using the relative transformation matrix stored in its structure.

### EXAMPLE

### Game Application

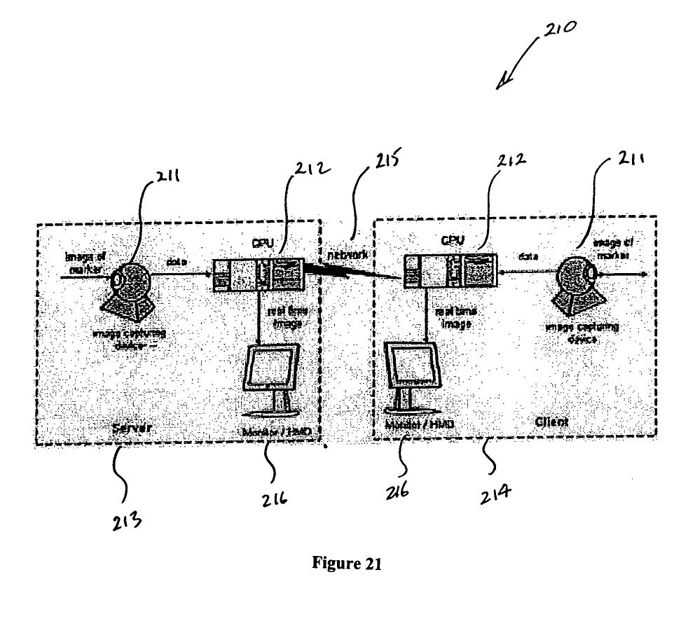

Referring to FIG. 21, a gaming system 210 is provided which combines the advantages of both a computer game and a traditional board game. The system 210 allows players to physically interact with 3D virtual objects while preserving social and physical aspects of traditional board games. Some of the features of the game include the ability to transit between the 3D AR world, 3D virtual reality world and physical world. A player can also navigate naturally through the 3D VR world by manipulating a cube. The tangible experience introduced by the cube goes beyond the limitation of two dimensional operation provided by a mouse.

The system 210 also facilitates network gaming to further enhance the experience of AR gaming. A network AR game allows players from all parts of the world to participate in AR gaming.

The system 210 uses two-handed interface technology in the context of a board game for manipulating virtual objects, and for navigating an augmented reality-enhanced game board or within a 3D VR environment. The system 210 also uses physical cubes as a tangible user interface.

Referring to FIG. 21, the system 210 includes a web cam or video camera 211 to capture images for detecting pre-defined markers. The pre-defined markers are stored in a computer. The computer 212 identifies whether a detected marker is recognized by the system 210. Data is sent from the server 213 to the client 214 via networking 215. Virtual objects are augmented onto the marker before outputting to a monitor 216 or head-mounted display (HMD).

In one example, the system 210 is deployed over two desktop computers 213, 214. One computer is the server 213 and the other is the client 214. The server 213 and client 214 both have Microsoft DirectX installed. Microsoft DirectX is an advanced suite of multimedia application programming interfaces (APIs) built into Microsoft Windows operating systems. IEEE1394 cameras 211 including the Dragonfly cameras and the Firefly cameras are used to capture images. Both cameras 211 are able to capture color images at a resolution of 640×480 pixels, at the speed of 30 Hz. For recording of video streams, the amount and speed of the data transfer requirements is considerable. For one camera to record at 640×480 pixels 24 bit RGB data at 30 Hz, this transposes into a sustained data transfer rate of 27.6 megabytes per second. Similar to a traditional board game, the gaming system 210 provides a physical game board and cubes for a tangible user interface.

Similar to the story book application, the software used includes Microsoft Visual C++ 6.0, OpenGL, GLUT and the Realspace MXR Development Toolkit.

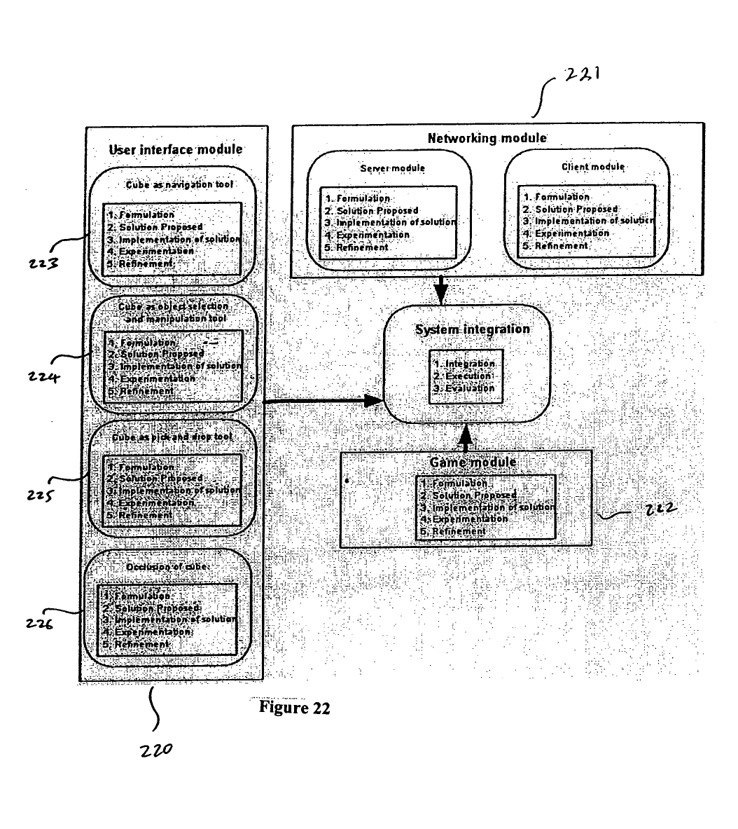

Referring to FIG. 22, the system 210 is generally divided into three modules: user interface module 220, networking module 221 and game module 222.

The user interface module 220 enables the interactive techniques using the cube to function. These techniques include changing the point of view, occlusion of physical object from virtual environment 226, object manipulation 224, navigation 223 and pick and drop tool 225.

Changing the point of view enables objects to be seen from many different angles. This allows occlusions to removed or reduced and improves the sense of the three-dimensional space an object occupies. The cube is a hand-held model which allows the player to quickly establish different points of view by rotating the cube in both hands. This provides the player all the information that he or she needs without destroying the point of view established in the larger, immersive environment. This interactive technique can establish a new viewpoint more quickly.

In an augmented environment, virtual objects often obstruct the current line of sight of the player. By occluding the physical cube from the virtual space 226, the player can establish an easier control of the physical object in the virtual world.

The cube also functions as a display anchor and enables virtual objects such as 3D models, graphics and video, to be manipulated at a greater than one-to-one scale, implementing a three-dimensional magnifying glass. This gives the player very fine grain control of objects through the cube. It also allows a player to zoom in to view selected virtual objects in greater detail, while still viewing the scene in the game.

The cube also allows players to rotate virtual objects naturally and easily compared to ratcheting (repeated grabbing, rotating and releasing) which is awkward. The cube allows rotation using only fingers, and complete rotation through 360 degrees.

The cube represents the player's head. This form of interface is similar to the joystick. Using the cube, 360 degrees of freedom in view and navigation is provided. By rotating and tilting the cube, the player is provided with a natural 360 degree manipulation of their point of view. By moving the cube left and right, up and down, the player can navigate through the virtual world.

The pick-and-drop tool of the cube increases intuitiveness and supports greater variation in the functions using the cube. For example, the stacking of two cubes on top of one another provides players with an intuitive way to pick and drop virtual items in the augmented reality (AR) world.

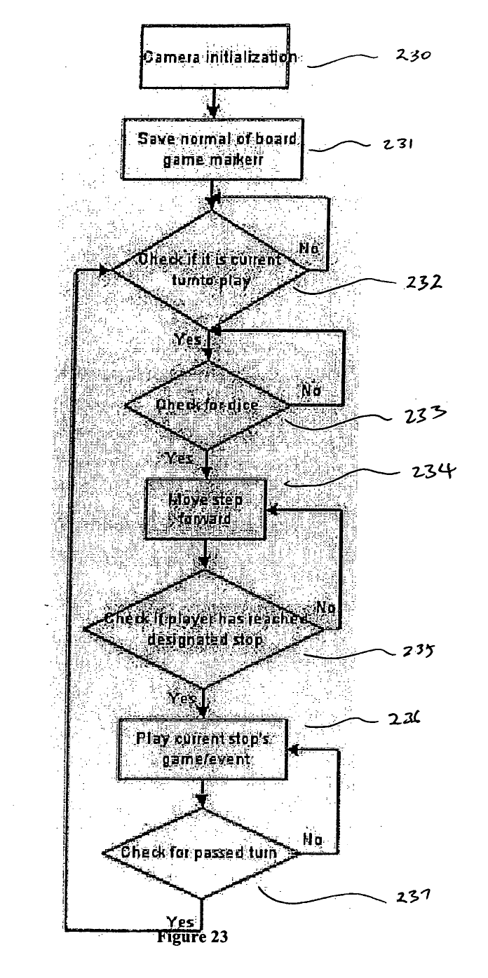

Referring to FIGS. 22 and 23, the game module 222 handles the running details of the game. This module 222 ensures communication between the player and the system 210. Predicting player behaviour also ensures smooth running of the system 210. The game module 222 performs some initialisation steps such as camera initialisation 230 and saving the normal of the board game marker 231. The current turn to play is checked 232, and if so, the dice is checked 233 to determine how many steps to move 234 the player forward on the game board. If the player reaches a designated stop 235 on the game board, a game event of the stop is played 236. Game events include a quiz, a task or a challenge for the player to answer or perform. Next, there is a check for whether the turn has been passed 237 and repeats checking if it is the current turn to play 232.

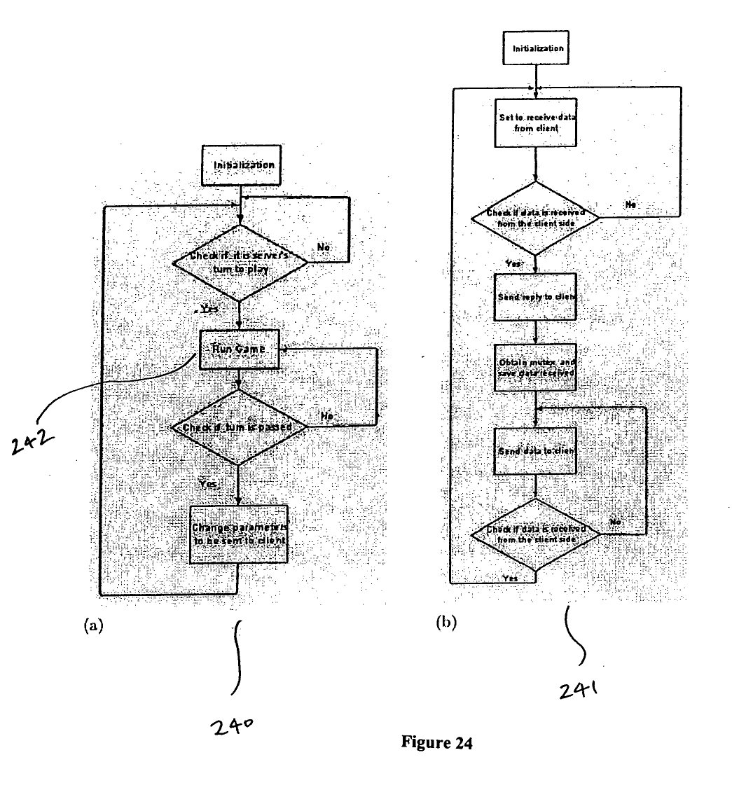

The networking module 221 comprises two components in communication with each other: the server 213 and the client 214 components. The networking module 221 also ensures mutual exclusion of globally shared variables that the game module 222 uses. In each component 213, 214, two threads are executed. Referring to (a) in FIG. 24, one thread is the game thread 240 used to run the functions of the game. This includes detection and recognition of markers, calculating matrix transforms and all other functions that are involved in running the game 242. Referring to (b) in FIG. 24, the other thread is the network thread 241 used to establish a network 215 between the client 214 and the server 213. This thread is also used to send and receive data via the network 215 between the server 213 and the client 214.

Implementation of an AR gaming system 210 relies on 3D perspective projection. 3D projection is a mathematical process to project a series of 3D shapes to a 2D surface, usually a computer monitor 216. Rendering refers to the general task of taking some data from the computer memory and drawing it, in any way, on the computer screen. The gaming system 210 uses a 4×4 matrix viewing system.

The transformation of the viewing transformation matrix consists of a translation, two rotations, a reflection, and a third rotation. The translation places the origin of the viewing coordinate system (xv, yv, zv) at the camera position, which is specified as the vector V=(a, b, c) in world coordinates (xw, yw, zw). The translation matrix is

$$T 1 = [ \begin{matrix}1 & 0 & 0 & 0 \\ 0 & 1 & 0 & 0 \\ 0 & 0 & 1 & 0 \\ - a & - b & - c & 1\end{matrix} ]$$

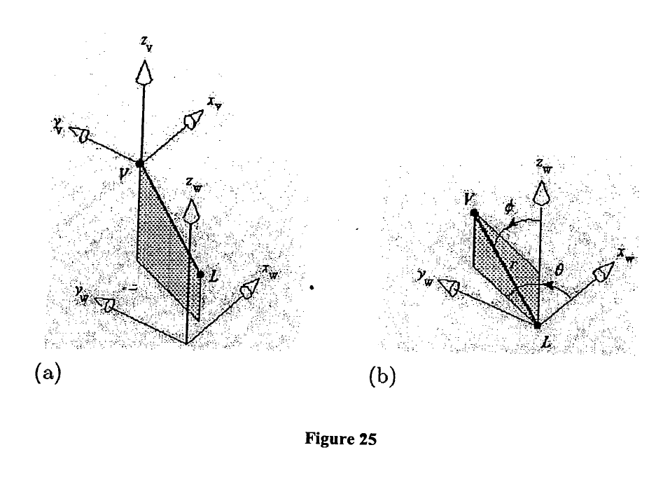

and leaves the world and viewing coordinate systems as shown at (a) of FIG. 25, where L=(e, f, g) is the look at point. The angles Θ and Φ are defined by first translating the look at point to the origin of the world coordinates and simultaneously translating the camera position through the vector tL. This does not change the orientation of the vector V t L. The angles are defined at (b) of FIG. 25, where Θ is in the (xw, yw) plane, Φ is in the vertical plane defined by V, L, and the zw axis, and the quantity r=jV t Lj. This transformation of the camera and look at positions is only to make the definitions of r, Θ, and Φ clear; it is not applied to the viewing coordinate system, whose origin remains at the camera position V.

With r, Θ, and Φ defined as above, we have the following expressions:
r=[(ate)2+(btf)2+(ctg)2]½,
sin θ=(btf)/[(ate)2+(btf)2]½,
cos θ=(ate)/[(ate)2+(btf)2]½,
sin φg=[(ate)2+(btf)2]½/r,
cos φ=(ctg)/r.

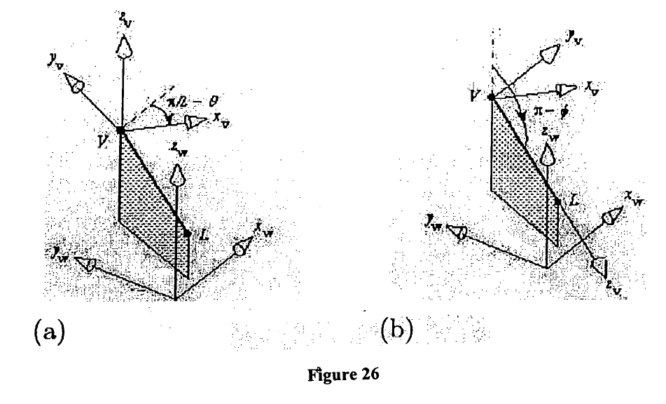

Referring to (a) of FIG. 26, the first rotation applied to the viewing coordinate system is a clockwise rotation through ng/g2 t Θ about the zv axis to make the xv axis normal to the vertical plane containing r. The matrix for this is:

$$T 2 = [ \begin{matrix}sin θ & cos θ & 0 & 0 \\ - cos θ & sin θ & 0 & 0 \\ 0 & 0 & 1 & 0 \\ 0 & 0 & 0 & 1\end{matrix} ]$$

The second rotation is counterclockwise through ng-gΦ about the xv axis, which leaves the zv axis parallel and coincident with the line joining the camera and look at positions. The matrix for this rotation is:

$$T 3 = [ \begin{matrix}1 & 0 & 0 & 0 \\ 0 & - cos ϕ & - sin ϕ & 0 \\ 0 & sin ϕ & - cos ϕ & 0 \\ 0 & 0 & 0 & 1\end{matrix} ]$$

and (b) of FIG. 26 shows the orientation of the viewing coordinate axes after this rotation. The next transformation is a reflection across the (yv, zv) plane to convert the viewing coordinates to a left handed coordinate system, and is represented by the matrix:

$$T 4 = [ \begin{matrix}- 1 & 0 & 0 & 0 \\ 0 & 1 & 0 & 0 \\ 0 & 0 & 1 & 0 \\ 0 & 0 & 0 & 1\end{matrix} ]$$

The final transformation is a rotation through the twist angle α in a counter clockwise direction about the zv axis, represented by the rotation matrix:

$$T 5 = [ \begin{matrix}cos α & - sin α & 0 & 0 \\ sin α & cos α & 0 & 0 \\ 0 & 0 & 1 & 0 \\ 0 & 0 & 0 & 1\end{matrix} ]$$

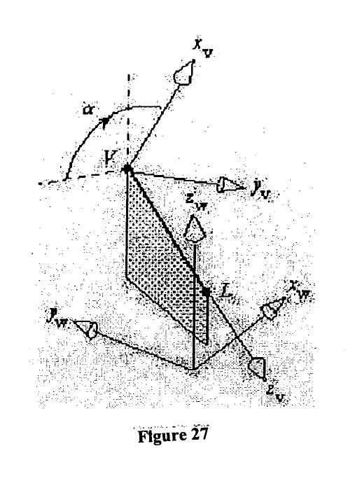

This leaves the final orientation of the viewing coordinates as shown in FIG. 27.

Multiplying the matrices T1 tT5 gives the matrix Tv which transforms world coordinates to viewing coordinates:

$$\begin{matrix}{T}_{v} = {T}_{1} {T}_{2} {T}_{3} {T}_{4} {T}_{5} \\ = [ \begin{matrix}- cos α sin θ - sin α cos θ cos ϕ & sin α sin θ - cos α cos θ cos ϕ & - cos θ sin ϕ & 0 \\ cos α cos θ - sin α sin θ cos ϕ & - sin α cos θ - cos α sin θ cos ϕ & - sin θ sin ϕ & 0 \\ sin α sin ϕ & cos α sin ϕ & - cos ϕ & 0 \\ \begin{matrix}cos α ( a sin θ - b cos θ ) + \\ \begin{matrix}sin α ( a cos θ + b sin θ ) cos ϕ - \\ c sin α sin ϕ\end{matrix}\end{matrix} & \begin{matrix}- sin α ( a sin θ - b cos θ ) + \\ cos α ( a cos θ + b sin θ ) cos ϕ - \\ c cos α sin ϕ\end{matrix} & \begin{matrix}( a cos θ + b sin θ ) sin ϕ + \\ c cos ϕ \\ \end{matrix} & 1\end{matrix} ]\end{matrix}$$

The first step is to transform the points coordinates taking into account the position and orientation of the object they belong to. This is done using a set of four matrices:
Object Translation:

$$( \begin{matrix}1 & 0 & 0 & x \\ 0 & 1 & 0 & y \\ 0 & 0 & 1 & z \\ 0 & 0 & 0 & 0\end{matrix} )$$

Rotation about the X Axis

$$( \begin{matrix}1 & 0 & 0 & 0 \\ 0 & cos α & - sin α & 0 \\ 0 & sin α & cos α & 0 \\ 0 & 0 & 0 & 1\end{matrix} )$$

Rotation about the Y Axis

$$( \begin{matrix}cos β & 0 & sin β & 0 \\ 0 & 1 & 0 & 0 \\ - sin β & 0 & cos β & 0 \\ 0 & 0 & 0 & 1\end{matrix} )$$

Rotation about the Z Axis

$$( \begin{matrix}cos γ & - sin γ & 0 & 0 \\ sin γ & cos γ & 0 & 0 \\ 0 & 0 & 1 & 0 \\ 0 & 0 & 0 & 1\end{matrix} )$$

The four matrices are multiplied together, and the result is the world transform matrix: a matrix that if a point's coordinates were multiplied by it, would result in the point's coordinates being expressed in the “world” reference frame.

In contrast to multiplication between numbers, the order used to multiply the matrices is significant. Changing the order will also change the result. When dealing with the three rotation matrices, a fixed order, ideal for the circumstance must be chosen. The object is rotated before it is translated, since the position of the object in the world would get rotated around the centre of the world, wherever that happens to be. [World Transform]=[Translation]×[Rotation].

The second step is virtually identical to the first one, except that it uses the six coordinates of the player instead of the object, and the inverses of the matrixes should be used, and they should be multiplied in the opposite order, (A×B)−1=B−1×A−1. The resulting matrix transforms coordinates from the world reference frame to the player's reference frame. The camera looks in its z direction, the x direction is typically left, and the y direction is typically up.

Inverse object translation is a translation in the opposite direction:

$$( \begin{matrix}1 & 0 & 0 & - x \\ 0 & 1 & 0 & - y \\ 0 & 0 & 1 & - z \\ 0 & 0 & 0 & 0\end{matrix} )$$

Inverse rotation about the X axis is a rotation in the opposite direction:

$$( \begin{matrix}1 & 0 & 0 & 0 \\ 0 & cos α & sin α & 0 \\ 0 & - sin α & cos α & 0 \\ 0 & 0 & 0 & 1\end{matrix} )$$

Inverse rotation about the Y axis:

$$( \begin{matrix}cos β & 0 & - sin β & 0 \\ 0 & 1 & 0 & 0 \\ sin β & 0 & cos β & 0 \\ 0 & 0 & 0 & 1\end{matrix} )$$

Inverse rotation about the Z axis:

$$( \begin{matrix}cos γ & sin γ & 0 & 0 \\ - sin γ & cos γ & 0 & 0 \\ 0 & 0 & 1 & 0 \\ 0 & 0 & 0 & 1\end{matrix} )$$

The two matrices obtained from the first two steps are multiplied together to obtain a matrix capable of transforming a point's coordinates from the object's reference frame to the observer's reference frame.
[Camera Transform]=[Inverse Rotation]×[Inverse Translation]
[Transform so far]=[Camera Transform]×[World Transform]

The graphical display of 3D virtual objects requires tracking and manipulation of 3D objects. The position of a marker is tracked with reference to the camera. The algorithm calculates the transformation matrix from the marker coordinate system to the camera coordinate system. The transformation matrix is used for precise rendering of 3D virtual objects into the scene. The system 210 provides a tracking algorithm to track a cube having six different markers, one marker per surface of the cube. The position of each marker relative to one another is known and fixed. Thus, to identify the position and orientation of the cube, the minimum requirement is to track any of the six markers. The tracking algorithm also ensures continuous tracking when hands occlude different parts of cube during interaction.

The tracking algorithm is as follows:

1) An eight-point tracking algorithm is applied. The marker design comprises a border which allows tracking of eight vertexes (inner and outer) enabling more robust tracking due to more information provided. The inner and outer eight vertexes are tracked and this enables a more robust tracking result. The marker has a gap in the border at one of the four sides. This breaks the symmetry of the square thus allowing use of a symmetrical pattern in the center of the marker and differentiation of same patterns in different orientations. Alternatively, an asymmetrical geometrical pattern can be used.

2) The algorithm tracks the entire cube in an image form, and this enables a correct display of occlusion relationships.

3) The algorithm enables more robust tracking of the cube and requires only one face of the cube to be tracked. Using the current tracking face, the algorithm automatically calculates the transformation from the face coordinate system to the cube coordinate system. This algorithm ensures continuous tracking when hands cover a portion of the cube during interaction.

4) The algorithm enables direct manipulation of cubes with hands. In most situations, only one hand is used to manipulate the cube. The cube is always tracked as long as at least one face of the cube is detected.

Tracking the cube involves:

1) detecting all the surfaces markers and calculate the corresponding transformation matrix Tcm for each detected surfaces;

2) choosing a surface with the highest tracking confidence and identifying its surface ID, that is whether it is the top, bottom, left, right, front, or back face.

3) calculating the transformation matrix from the marker coordinate system to the object coordinate system Tmo based on the physical relationship of the chosen marker and the cube.

4) The transformation matrix from the object coordinate system to the camera coordinate system Tco is calculated by:
Tco=Tcm×Tmo

By detecting the physical orientation of the cube, the cube represents the virtual object which is associated with the physical top marker relative to the world coordinates. The “top” marker is not the “top” marker defined for a specific surface ID but the actual physical marker facing up. However, the top marker in the scene may be changed when the player tilts his/her head. So, during initialization of the application, a cube is placed on the desk and the player keeps their head without any tilting or panning. This Tco is saved for later comparison to examine which surface of the cube is facing upwards. The top surface is determined by calculating the angle between the normal of each face and the normal of the cube calculated during initialization.

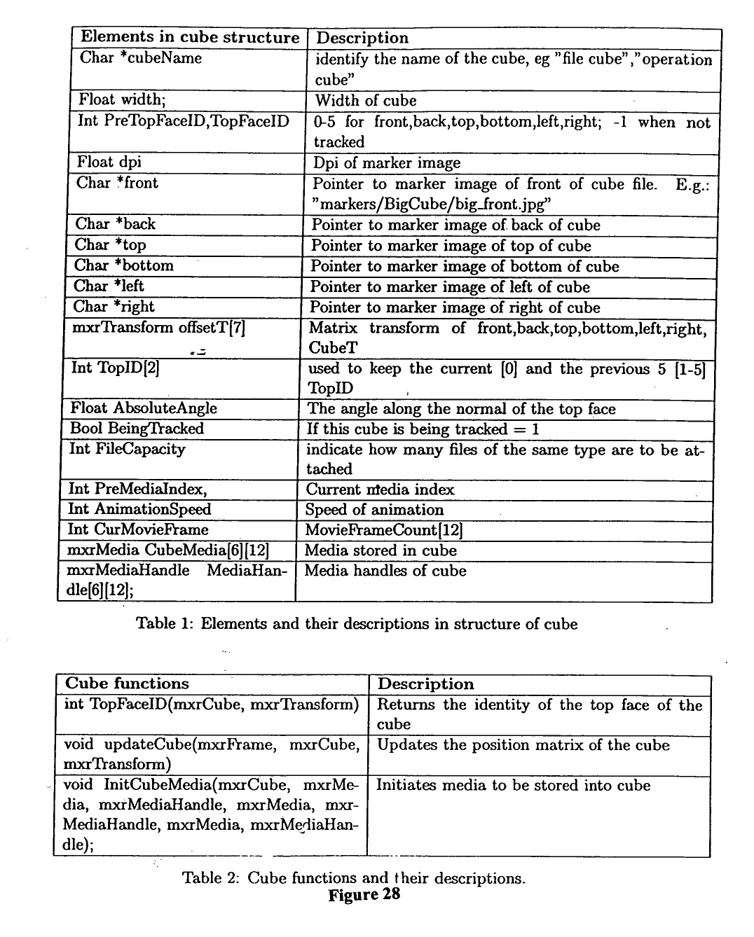

A data structure is used to hold information of the cube. The elements in the structure of the cube and their descriptions are shown in Table 1 of FIG. 28. Important functions of the cube and their description are shown in Table 2 of FIG. 28.

Virtual objects obstructing the view of the physical objects hinders the player using the physical objects in a Augmented Reality (AR) world. A solution requires occluding the cube. Occlusion is implemented using OpenGL coding. The width of the cube is first pre-defined. Once the markers on the cube are detected, the glVertex3f( ) function is used to define four corners of the quadrangle. OpenGL quadrangles are then drawn onto the faces of the cube. By using the glColorMask( ) function, the physical cube is masked out from the virtual environment.

The occlusion of the cube is useful since when physical objects do not obstruct the player's line of sight, the player has a clearer picture of their orientation in the AR world. Although the cube is occluded from the virtual objects, it is a small physical element in the entire AR world. The physical game board is totally obstructed from the player's view. However, it is not desirable to occlude the entire physical game board as this defeats the whole purpose of augmenting virtual objects into the physical world. Thus, the virtual game board is made translucent so that the player can see hints of physical elements beneath it.

In most 3D virtual computer games, 3D navigation requires use of keyboard arrow keys for moving forward, and some letter keys for turning the head view and some other keys to tilt the head. With so many different keys to bear in mind, players often find it difficult to navigate within virtual reality environments. This game 210 replaces keyboards, mice and other peripheral input devices with a cube as a navigation tool and is treated as a “virtual camera”.

Since, [Camera Transform]=[Inverse Rotation]×[Inverse Translation]

mxrTransformInvert(&tmpInvT,&myCube[2].offsetT[3]) is used to calculate the inverse of the marker perpendicular to the table top, which in this case is myCube[2].offset[3]. The transform of the cube is then projected as the current camera transform. In other words, the view point from the cube is obtained. Moving the cube left in the physical world requires a translation to the left in the virtual world. Rotating and tilting the cube requires a similar translation.

To create an easy and natural way for the player to use the cube as a “pick and drop” tool, a CubeIsStacked function is implemented. This function facilitates players in tasks such as pick-and-drop and turn passing. This function is implemented firstly by taking the perspective of the top cube with respect to the bottom cube. As discussed earlier, this is done by taking the inverse of the top cube and multiplying it with the bottom cube.

The stacking of cubes is determined by three main conditions:

1) The difference of “z” distance between the two cubes is not more than the height of the top cube.

2) The distance between the two cubes does not exceed the square root of (x2+y2+z2). This ensures that if by sheer chance a cube is held in such a way that the perspective “z” distance is equal to the height of the top cube but not directly stacked on top of it, it will not be recognized as a stacked cube.

3) The difference between the normal of the top cube and the bottom cube does not exceed a certain threshold. This prevents the top cube being tilted and being recognized as stacked even though the previous two conditions are satisfied.

Due to vision-based tracking, the bottom cube must be tracked in order to detect if any cube stacking has occurred.

An intuitive and natural way for players to select and manipulate virtual objects is provided. The virtual objects are pre-stored in an array. Changing an index pointing to the array selects a virtual object. This is implemented by calculating the absolute angle (the angle along the normal of the top cube). By using this angle, an index is specified such that for every “x” degree, a file change is invoked. Thus, different virtual objects are selectable by simple manipulation of the cube.

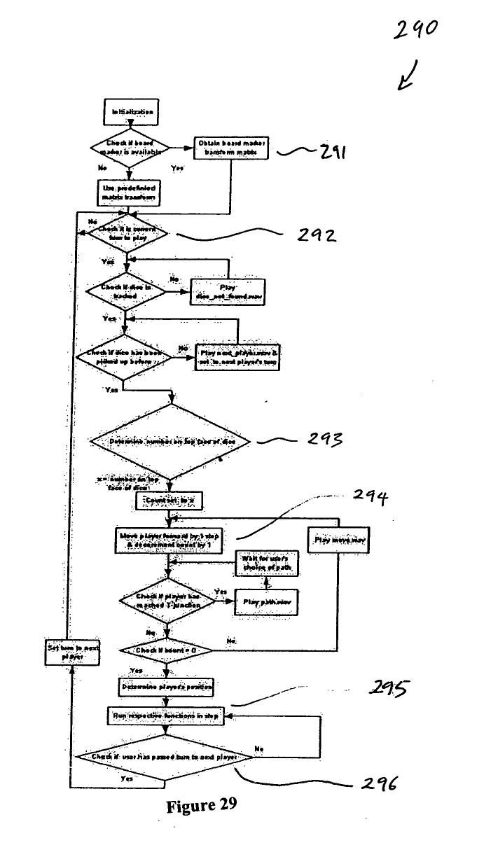

Referring to FIG. 29, the flow of the game logic 290 for the game module 222 is as follows:

1) Obtain the physical game board marker transform matrix 291, and save it as the normal of the table top. This normal is used in detecting the top face of the cube.

2) Check if it is a current turn to play the game 292.

3) If it is a current turn to play the game. Play the sound hint to roll the dice.

4) If the dice is not detected, this indicates that the player has picked up the dice and but not thrown in onto the game board.

5) If the dice is detected, it means the player has thrown the dice or the player has not picked up the dice yet. Thus, the indication of dice being thrown only happens if the dice has been not detected before.

6) Once the dice is thrown, the top face of the cube is detected, to determine the number on the top face of the dice 293.

7) The virtual object representing the player is moved automatically according to the number shown on the top face of the dice 294.

8) If a player lands on an action step, a game event occurs 295. The user interface module handles the game event.

9) Once a player has decided to pass the turn to the next player 296, they stack the dice on top of the control cube to indicate the turn is passed to next player.

Miscommunication between the player and the system 210 is addressed by providing visual and sounds hints to indicate the functions of the cube to the players. Some of the hints include rendering a rotating arrow on the top face of the cube to indicate the ability to rotate the cube on the table top, and text directing instructions to the players. Sound hints include recorded audio files to be played when dice is not found, or to indicate to roll the dice or to choose a path.

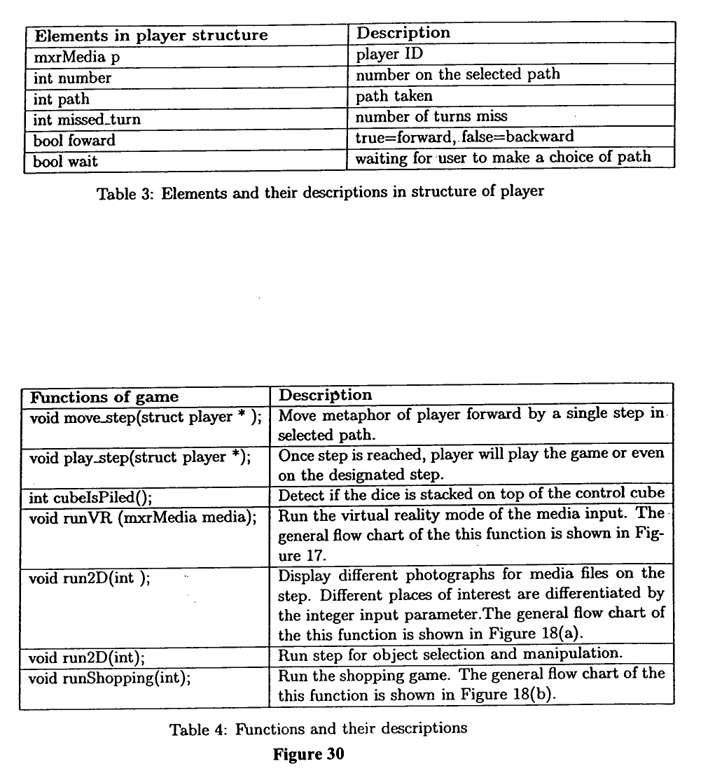

A database is used to hold player information. Alternatively, other data structures may be used. The elements in the database and their descriptions are listed in Table 3 of FIG. 30. Important functions written by the game development and their description are listed in Table 4 of FIG. 30.

In the networking module 221, threading provides concurrency in running different processes. A simple thread function is written to creating two threads. One thread runs the networking side; StreamServer( ), while the other is to run the game mxrGLStart( ). The code for the thread function is as follows:

```
DWORD WINAPI ThreadFunc( LPVOID lpParam )
{
  char szMsg[80];
    if (*(DWORD*)lpParam==1){
      while (true){
      StreamServer(nPort);}
    }
    if (*(DWORD*)lpParam==2){
      mxrGLStart(mxrMain, mxrlKeyboard, mxrGLReshapeDefault);)
  return 0;
}
```

This thread function is called in the main program as follows:

```
/ [symbol] threading start [symbol] /
  DWORD dwThreadId, dwThrdParam − 1; dwThrdParam2 − 2;
  HANDLE hThread1, hThread2;
  char szMsg[60];
  hThread1 - CreateThread(
    NULL,  // default security attributes
    0,  // use default stock size
    ThreadFunc,  //thread function
    &dwThrdParam,  // argument to thread function
    0,  // use default creation flags
    &dwThread(d)  // returns the thread identifier
  // Check the return value for success
  if (hThread1 == NULL)
  { [symbol]
    ( szMsg, “CreateThread [symbol] ” ),
    MessageBox[NULL, szMsg, “main”, MB_OK ];
  }
  else
  {
    //_getch( );
    CloseHandle( hThread1 );
  }
  hThread2 = CreateThread(
    NULL,  // default security attributes
    0,  // use default stock size
    ThreadFunc,  //thread function
    &dwThrdParam2,  // argument to thread function
    0,  // use default creation flags
    &dwThread(d),  // returns the thread identifier
  // Check the return value for success.
  if (hThread2 == NULL)
  { [symbol]
    (szMsg, “CreateThread [symbol] ” ),
    MessageBox( NULL, szMsg, “main”, MB_OK ),
  }
  else
  {
    //_getch( );
    CloseHandle( hThread2 ); }
/ [symbol] threading end [symbol] /
```

In order to protect mutual exclusion of globally shared data such as global variables, mutexes are used. Before any acquisition or saving of any global variable, a mutex for that respective variable must be obtained. These globally shared variables include current status of turn, and player's current step and the path taken. This is implemented using the function CreateMutex ( ).

The TCP/IP stream socket is used as it supports server/client interaction. Sockets are essentially the endpoints of communication. After a socket is created, the operating system returns a small integer (socket descriptor) that the application program (server/client code) uses this to reference the newly created socket. The master (server) and slave (client) program then binds its hard-coded address to the socket and a connection is established.

Both the server 213 and client 214 are able to send and receive messages, ensuring a duplex mode for information exchange. This is achieved through the send(connected socket, data buffer, length of data, flags, destination address, address length) and recv(connected socket, message buffer, flags) functions. Two main functions: StreamClient( ) and StreamServer( ) are provided. For a network game, reasonable time differences and latency are acceptable. This permits verification of data transmitted between client and server after each transmission, to ensure the accuracy of transmitted data.

### EXAMPLE

### Mobile Phone Augmented Reality System

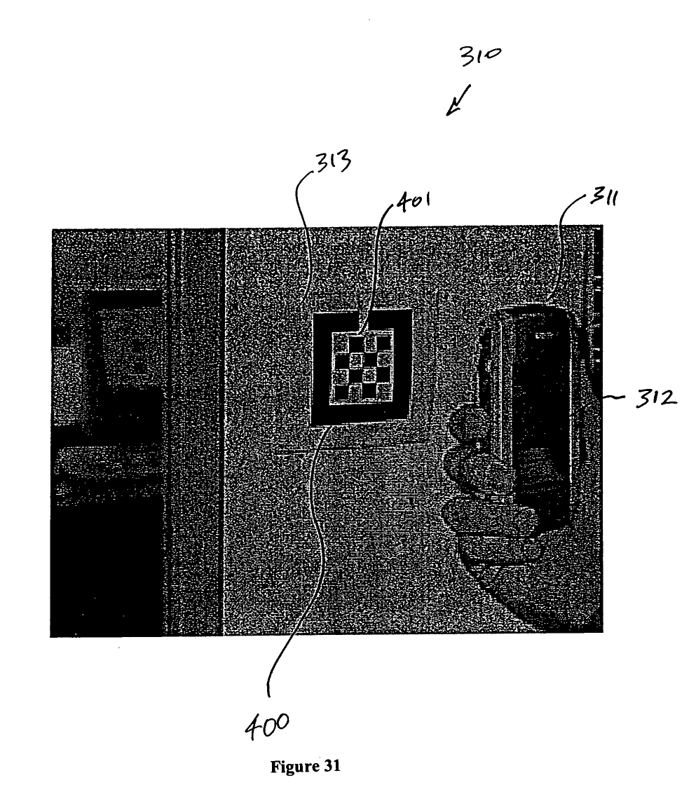

Referring to FIG. 31, a mobile phone augmented reality system 310 is provided which uses a mobile phone 311 as an Augmented Reality (AR) interface. A suitable mobile phone 311 preferably has a color screen 312, a digital camera and is wireless-enabled. One suitable mobile phone 311 is the Sony Ericsson P800 311. The operating system of the P800 311 is Symbian version 7. The P800 311 includes standard features such as a built-in camera, a large color screen 312 and is Bluetooth enabled.

Symbian UIQ 2.0 Software Development Kit (not shown) is typically used for developing software for the Sony Ericsson P800 mobile phone 311. The kit provides: binaries and tools to facilitate building and deployment of Symbian OS applications. Also, the kit allows the development of pen-based, touchscreen applications for mobile phones and PC emulators.

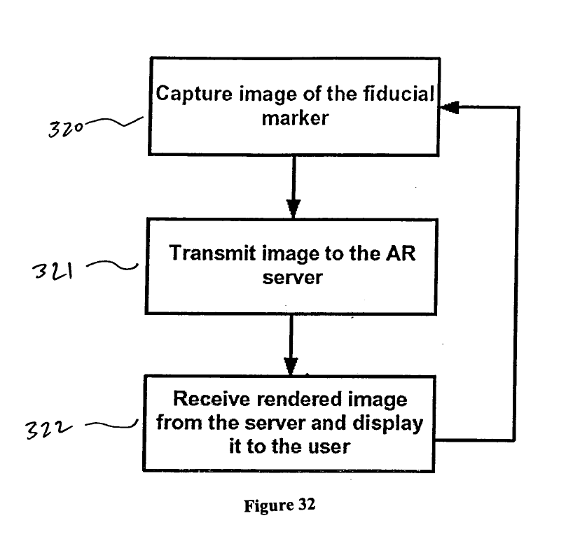

Referring to FIG. 32, in a typical scenario, the user captures 320 an image 313 having a marker 400 present in the image 313. The system 310 transmits 321 the captured image 313 to a server 330 via Bluetooth and displays 322 the augmented image 331 returned by the server 330.

The system 310 scans the local area for any available Bluetooth server 330 providing AR services. The available servers are displayed to the user for selection. Once a server 330 is selected, a Bluetooth connection is established between the phone 311 and the server 330. When a user captures 320 an image 313, the phone 311 automatically transmits 321 the image 313 to the server 330 and waits for a reply. The server 330 returns an augmented image 331, which is displayed 322 to the user.

In one example, the majority of the image processing is conducted by the AR server 330. Therefore applications for the phone 311 can be kept simple and lightweight. This eases portability and distribution of the system 310 since less code needs to be re-written to interface different mobile phone operating systems. Another advantage is that the system 310 can be deployed across a range of phones with different capabilities quickly without significant reprogramming.

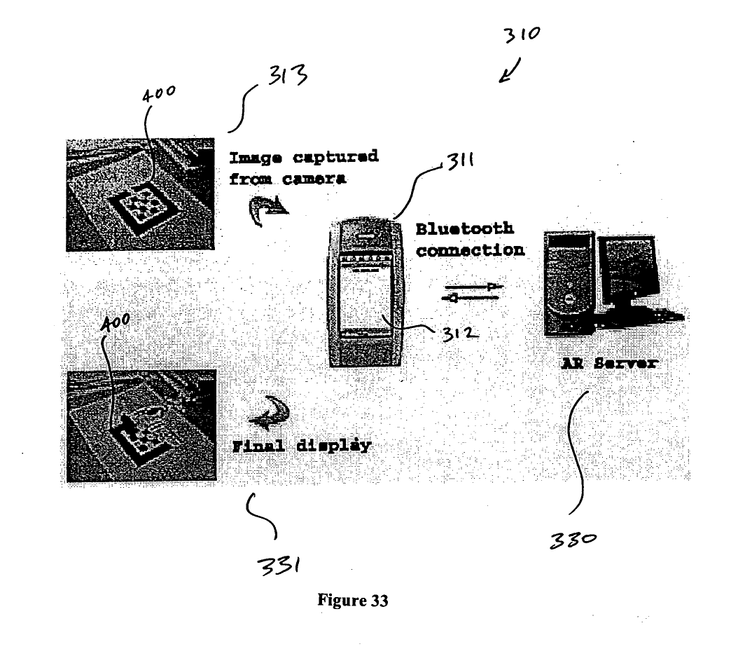

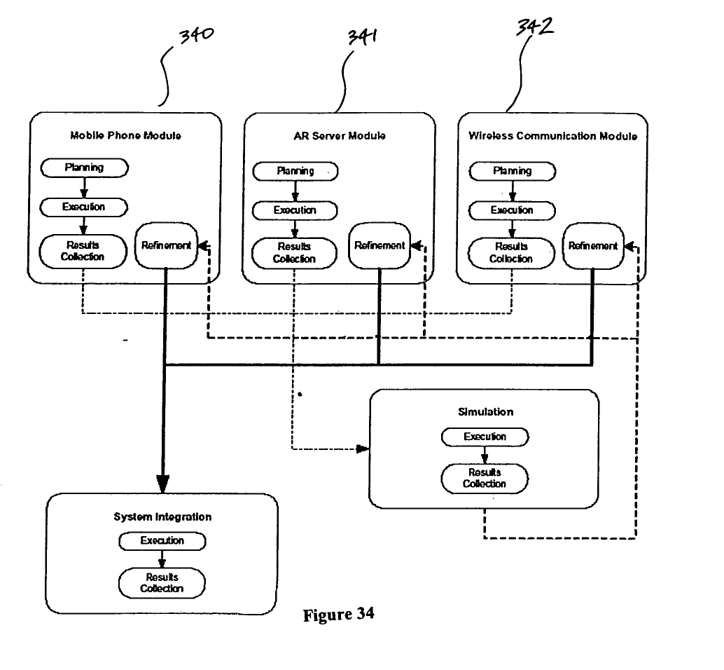

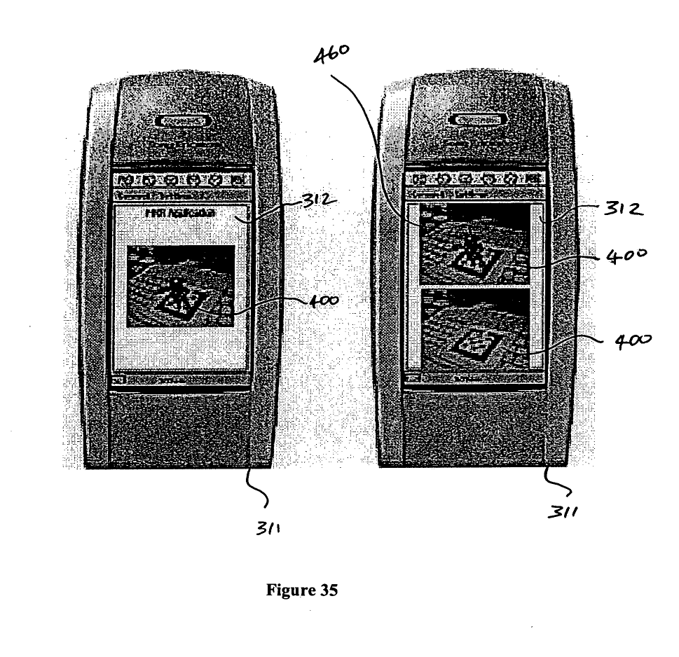

Referring to FIGS. 32 to 35, the system 310 has three main modules: mobile phone module 340 which is considered a client module, AR server module 341, and wireless communication module 342.

Mobile Phone Module

The mobile phone module 340 resides on the mobile phone 311. This module 340 enables the phone 311 to communicate with the AR server module 341 via the wireless communication module 342. The mobile phone module 340 captures an image 313 of a fiducial marker 400 and transmits the image 313 to the AR server module 341 via the Bluetooth protocol. An augmented result 331 is returned from the server 330 and is displayed on the phone's color display 312.

Images 313 can be captured at three resolutions (640×480, 320×240, and 160×120). The module 340 scans its local area for any available Bluetooth AR servers 330. Available servers 330 are displayed to the user for selection. Once an AR server 330 is selected an L2CAP connection is established between the server 330 and the phone 311. L2CAP (Logical Link Control and Adaptation Layer Protocol) is a Bluetooth protocol that provides connection-oriented and connectionless data services to upper layer protocols. When a user captures an image 313, the phone 311 sends it to the AR server 330 and waits to receive an augmented result 331. The augmented reality image 331 is then displayed to the user. At this point, a new image 313 can be captured and the process can be repeated as often as desired. For live video streaming, this process is automatically repeated continuously and is transparent to the user.

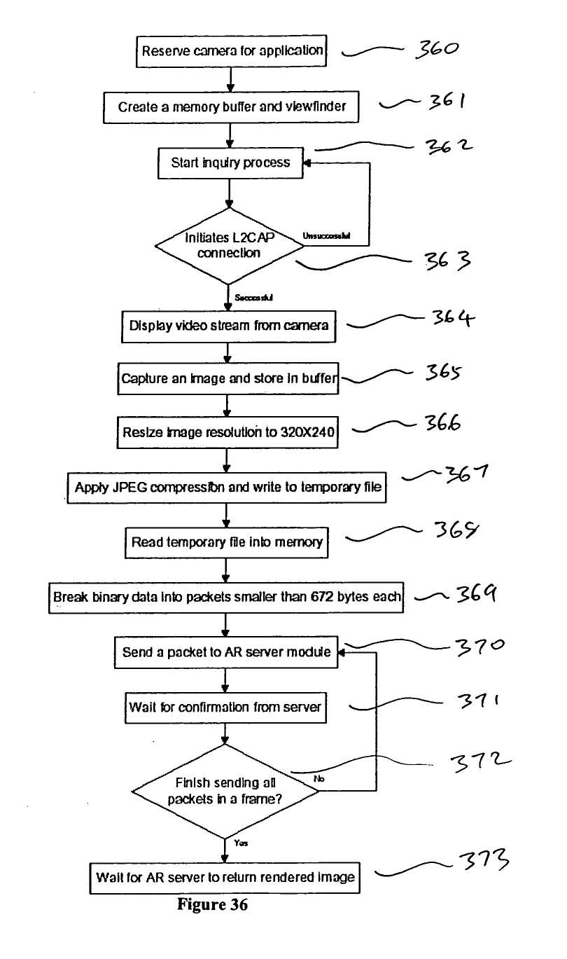

Referring to FIG. 36, the functions performed by the mobile phone module 340 are divided into two parts. The first part is focused on capturing an image 313 and sending it to the AR server module 341. This part has the following steps:

1. The module 340 is loaded and reserves 360 the camera on the mobile phone 311 for the system 310 to use exclusively.

2. A memory buffer is created 361 to store one image 313 and the viewfinder.

3. The user starts inquiry 362 of Bluetooth devices and selects an available AR server 330.

4. The mobile phone module 340 initiates 363 L2CAP connection with AR server 330.

5. If a successful connection is made, the module 340 displays 364 a video stream from the camera on the viewfinder.

6. The user clicks the capture button on the mobile phone 311 and captures 365 an image 313, if necessary, resizes 366 its resolution to 320×240 and stores it in the memory buffer.

7. JPEG compression is applied 367 to the image data in memory buffer and the compressed captured image is written into a temporary file.

8. The temporary JPEG file is read 368 into memory as binary data.

9. The binary data is broken 369 into packets smaller than 672 bytes each. This is due to constraints in the L2CAP protocol used in Bluetooth.

10. A “start” string is sent to the server 330 to indicate the start of transmission of an image 313.

11. One packet of data is sent 370 to the server 330 and the phone 311 waits 371 for confirmation from server 330.

12. When confirmation is received, the next packet is sent until all the packets relating to the image 313 are sent.

13. An “end” string is sent 372 to the server 330 to indicate the end of transmission of the image 313.

14. The phone 311 waits 373 for the AR server module 341 to return the augmented reality rendered image 331.

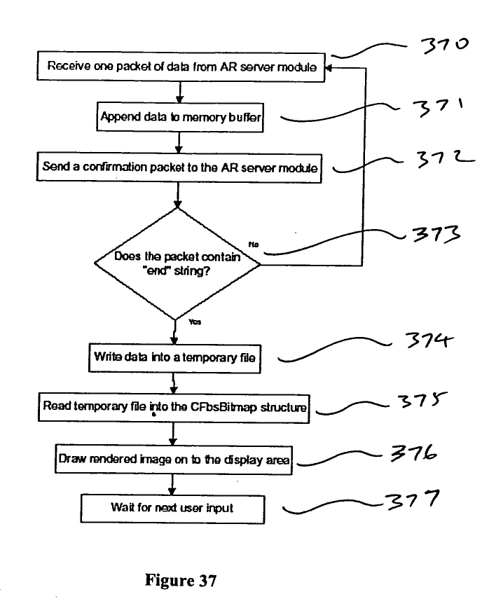

Referring to FIG. 37, the second part is focused on receiving the rendered image 331 from the AR server module 341 and displaying it on the screen 312 of the phone 311. This part has the following steps:

1. One packet of data of the rendered image 331 is received 370 from the AR server module 341.

2. Binary data is appended 371 to a memory buffer.

3. A confirmation packet is sent 372 to the AR server module 341.

4. The phone 311 waits 373 for the AR server module 340 to send the next packet until an “end” string is received.

5. Binary data of the rendered image 331 is written 374 in the memory buffer to a temporary file.

6. The temporary file is read 375 into the CFbsBitmap structure (the CFbsBitmap format is internal to Symbian UIQ SDK).

7. The rendered image 331 is drawn 376 onto the display area 312.

8. The phone 311 waits 377 for next user input.

Due to varying lighting conditions, the mobile phone module 340 provides users with the ability to change the brightness, contrast and image resolution so that optimum results can be obtained. Pull-down menus with options to change these parameters are provided in the user interface of the module 340.

Data in CfbsBitmap format is converted to a general format, for example, bitmap or JPEG before sending it to the server 330. JPEG is preferred because it is a compression format that reduces the size of the image and thus saves bandwidth when transferring to the AR server module 341.

AR Server Module

The AR server module 341 resides on the AR server 330. The server 330 is capable of handling high speed graphics animation as well as intensive computational processing. The module 341 processes the received image data 313 and returns an augmented reality image 331 to the phone 311 for display to the user. The images 313, 331 are transmitted through the system 310 in compressed form via a Bluetooth connection. The module 341 processes and manipulates the image data 313. The system 310 has a high degree of robustness and is able to consistently deliver accurate marker tracking and pattern recognition.

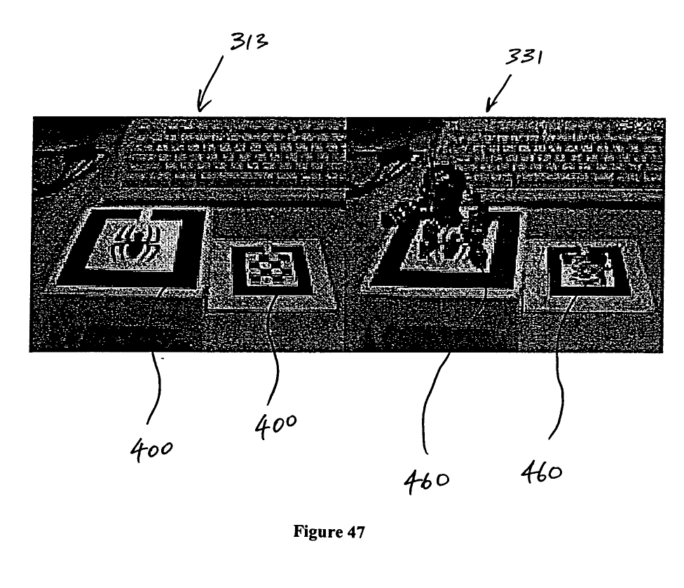

The processing and manipulation of image data is done mainly using the MXR Toolkit 500 included in the AR server module 341. The MXR Toolkit 500 has a wide range of routines to handle all aspects of building mixed reality applications. The AR server module 341 examines the input image 313 for a particular fiducial marker 400. If a marker 400 is found, the module 341 attempts to recognize the pattern 401 in the centre of the marker 400. Turning to FIG. 47, the MXR Toolkit 500 can differentiate between two different markers 400 with different patterns 401 even if they are placed side by side. Hence, different virtual objects 460 can be overlaid on different markers 400.

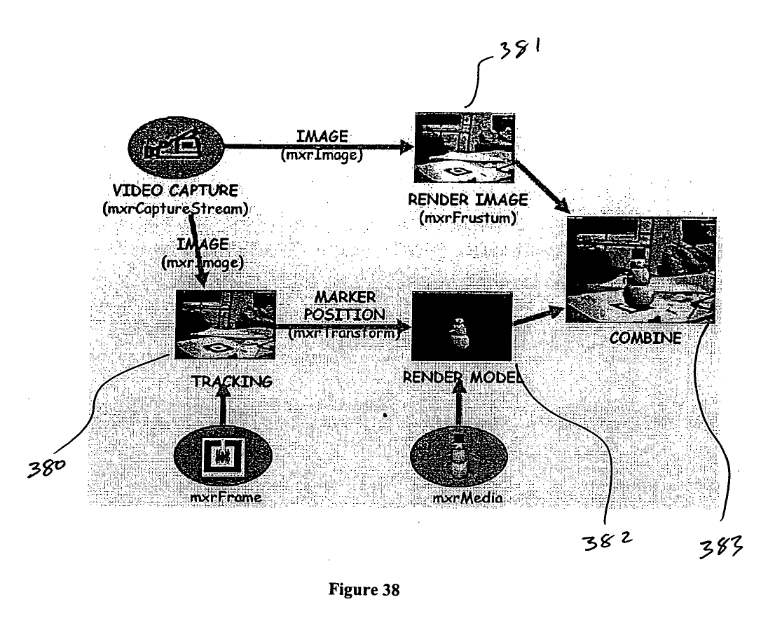

Referring to FIG. 38, the process flow of the MXR Toolkit 500 is illustrated. The toolkit 500 passes the image for tracking 380 the marker and renders 381 the virtual object onto the image 313. The marker position is identified 382, and then combined 383 with the rendered image, to position and orientate the virtual object in the scene correctly. After the image 313 is processed by the MXR Toolkit 500, the augmented result 331 is returned to the phone 311.

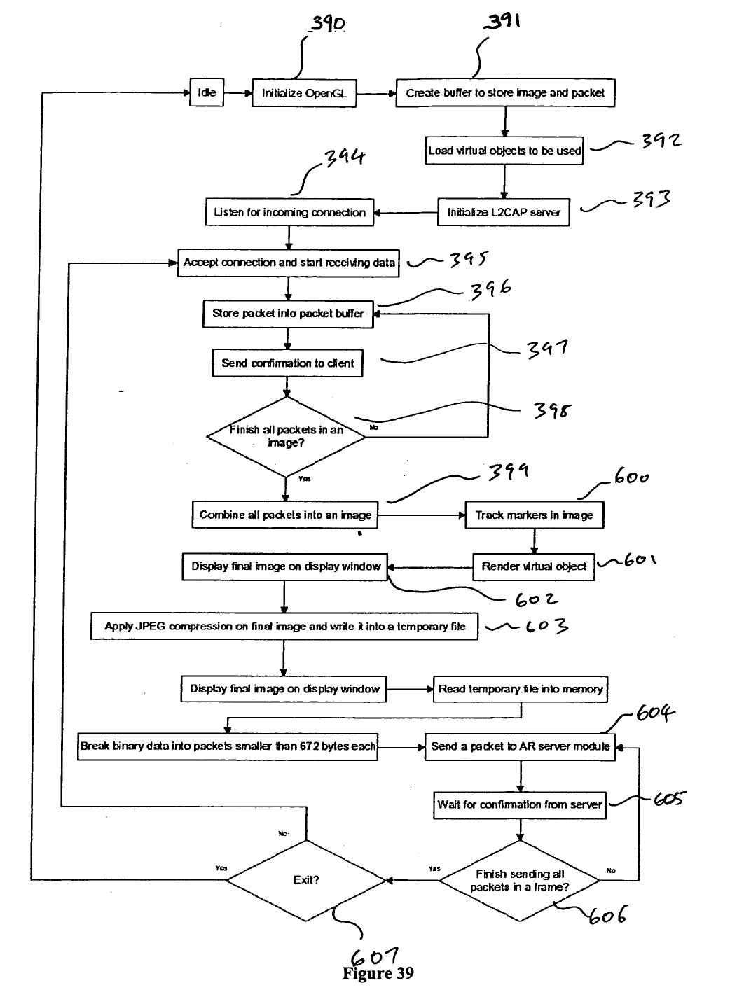

Referring to FIG. 39, the server module 341 performs marker 400 detection and rendering of virtual objects 460. The following steps are performed:

1. The server 341 is started and initializes 390 OpenGL by setting up a display window and the viewing frustum.

2. A memory buffer is created 391 to store packets received from client 340 (packet buffer) and the final image 331 (image buffer).

3. Information about markers 400 to be tracked is read in.

4. Virtual objects 460 to be displayed on the markers 400 later are loaded 392.

5. L2CAP service is initialized 393 and created.

6. Listen 394 for an incoming Bluetooth connection.

7. If there is an incoming connection, accept 395 the connection and start receiving data.

8. On receiving data, check whether it is the start of an image 313. If so, store 396 the packets into a packet buffer.

9. Send 397 confirmation to the client 311.

10. If 398 the data received is the end of the image 313, combine 399 the image 313 and store it in an image buffer.

11. Write data in the image buffer into a temporary JPEG file.

12. Load temporary file into memory as a JPEG image.

13. Track 600 markers 400 in the image 313.

14. If markers 400 are detected, render 601 virtual objects 460 in a relative position to the markers 400.

15. Display 602 the final image 331 on the display window.

16. Capture the final image 331, apply 603 JPEG compression and write it into a temporary file.

17. Send a “start” string to the client 311 to indicate the start of transmission of an image 331.

18. Send 604 one packet of data to the server 330 and wait for confirmation from server 330.

19. When confirmation is received 605, send the next packet until all the packets from the image 331 are sent 606.

20. Send an “end” string to the server 330 to indicate the end 607 of transmission of the image 331.

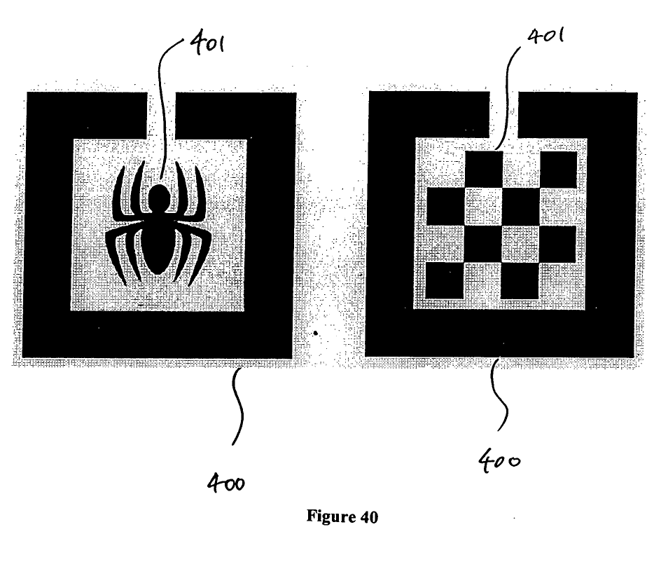

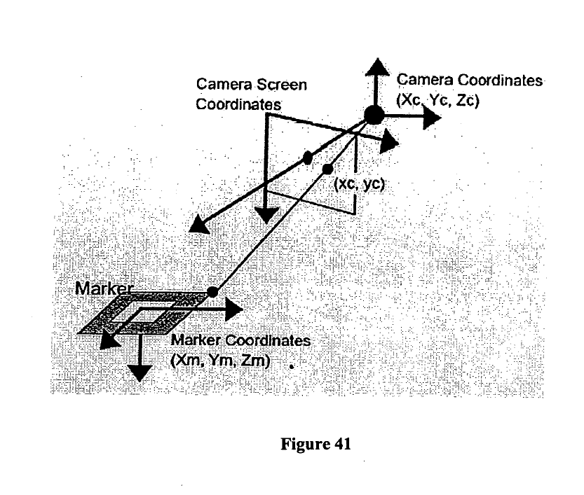

Referring to FIGS. 40 and 41, finding the location of a fiducial marker 400, requires finding the transformation matrices from the marker coordinates to the camera coordinates. Square markers 400 with a known size are used as a base of the coordinates frame in which virtual objects 460 are represented. The transformation matrices from these marker coordinates to the camera coordinates (Tcm) represented in (Equation 1) are estimated by image analysis:

$$\begin{matrix}[ \begin{matrix}{X}_{c} \\ {Y}_{c} \\ {Z}_{c} \\ 1\end{matrix} ] = [ \begin{matrix}{V}_{11} & {V}_{12} & {V}_{13} & {W}_{x} \\ {V}_{21} & {V}_{22} & {V}_{23} & {W}_{y} \\ {V}_{31} & {V}_{32} & {V}_{33} & {W}_{z} \\ 0 & 0 & 0 & 1\end{matrix} ] \\ = [ \begin{matrix}{X}_{m} \\ {Y}_{m} \\ {Z}_{m} \\ 1\end{matrix} ] \\ = [ \begin{matrix}{V}_{3 X3} & {W}_{3 X1} \\ 000 & 1\end{matrix} ] [ \begin{matrix}{X}_{m} \\ {Y}_{m} \\ {Z}_{m} \\ 1\end{matrix} ] \\ = {T}_{cm} [ \begin{matrix}{X}_{m} \\ {Y}_{m} \\ {Z}_{m} \\ 1\end{matrix} ]\end{matrix} \qquad ( Equation 1 )$$

After thresholding of the input image 313, regions whose outline contour can be fitted by four line segments are extracted. This is also known as image segregation. Parameters of these four line segments and coordinates of the four vertices of the regions found from the intersections of the line segments are stored for later processes. The regions are normalized and the sub-image within the region is compared by template matching with patterns 401 that were given by the system 310 before to identify specific user ID markers 400. User names or photos can be used as identifiable patterns 401. For this normalization process, (Equation 2) that represents a perspective transformation is used. All variables in the transformation matrix are determined by substituting screen coordinates and marker coordinates of detected marker's four vertices for (xc, yc) and (Xm, Ym) respectively. Next, the normalization process is performed using the following transformation matrix:

$$[ \begin{matrix}{hx}_{c} \\ {hy}_{c} \\ h\end{matrix} ] [ \begin{matrix}{N}_{11} & {N}_{12} & {N}_{13} \\ {N}_{21} & {N}_{22} & {N}_{23} \\ {N}_{31} & {N}_{32} & 1\end{matrix} ] = [ \begin{matrix}{X}_{m} \\ {Y}_{m} \\ 1\end{matrix} ] \qquad ( Equation 2 )$$

When two parallel sides of a square marker 400 are projected on the image 313, the equations of those line
a₁x+b₁y+c₁=0, a₂x+b₂y+c₂=0
segments in the camera's screen coordinates are the following:

(Equation 3)

For each of marker 400, the value of these parameters has been already obtained in the line-fitting process. Given the perspective projection matrix P obtained by the camera calibration in (Equation 4), equations of the planes that include these two sides respectively can be represented as (Equation 5) in the camera coordinates frame by substituting xc and yc in equation 4 for x and y in (Equation 3):

$$P = [ \begin{matrix}{P}_{11} & {P}_{12} & {P}_{13} & 0 \\ 0 & {P}_{22} & {P}_{23} & 0 \\ 0 & 0 & 1 & 0 \\ 0 & 0 & 0 & 1\end{matrix} ] , [ \begin{matrix}{hx}_{c} \\ {hy}_{c} \\ h \\ 1\end{matrix} ] = P [ \begin{matrix}{X}_{c} \\ {Y}_{c} \\ {Z}_{c} \\ 1\end{matrix} ] \\ {a}_{1} {P}_{11} {X}_{c} + ( {a}_{1} {P}_{12} + {b}_{1} {P}_{22} ) {Y}_{c} + ( {a}_{1} {P}_{13} + {b}_{1} {P}_{23} + {c}_{1} ) {Z}_{c} = 0 , \\ {a}_{2} {P}_{11} {X}_{c} + ( {a}_{2} {P}_{12} + {b}_{2} {P}_{22} ) {Y}_{c} + ( {a}_{2} {P}_{13} + {b}_{2} {P}_{23} + {c}_{2} ) {Z}_{c} = 0 \qquad ( Equations 4 \& 5 )$$

Given that normal vectors of these planes are n1 and n2 respectively, the direction vector of parallel two sides of the square is given by the outer product n1×n2. Given that two unit direction vectors that are obtained from two sets of two parallel sides of the square is u1 and u2, these vectors should be perpendicular. However, image processing errors mean that the vectors are not exactly perpendicular.

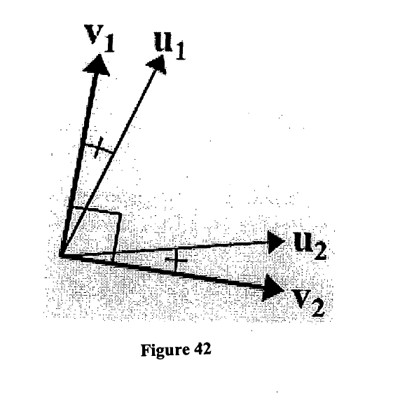

Referring to FIG. 42, to compensate for image processing errors, two perpendicular unit direction vectors are defined by v1 and v2 in the plane that includes u1 and u2. The two perpendicular unit direction vectors: v1, v2 are calculated from u1 and u2. Given that the unit direction vector which is perpendicular to both v1 and v2 is v3, the rotation component V3×3 in the transformation matrix Tcm from marker coordinates to camera coordinates specified in equation 1 is [V1t V2t V3t].

The rotation component V3×3 in the transformation matrix is given by (Equation 1), (Equation 4), the four vertices coordinates of the marker in the marker coordinate frame and those coordinates in the camera screen coordinate frame. Eight equations including translation component Wx Wy Wz are generated and the value of these translation component Wx Wy Wz can be obtained from these equations.

MXR Toolkit 500 provides an accurate estimation of the position and pose fiducial markers 400 in an image 313 captured by the camera. Virtual graphics 460 are rendered on top of the fiducial marker 400 by the manipulation of Tcm, which is the transformation matrices from marker coordinates to the camera coordinates. Virtual objects 460 are represented by 2D images or 3D models. When loaded into memory, they are stored as a collection of vertices and triangles. These vertices and triangles are viewed as a single point or vertex. Transformation of this single point or vertex usually involves translation, rotation and scaling.

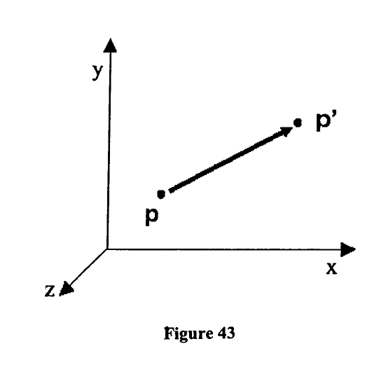

Referring to FIG. 43, translation displaces points by a fixed distance in a given direction. It has three degrees of freedom, because the three components of the displacement vector can be specified arbitrarily. This transformation is represented in (Equation 6).

In general, scaling is used to increase or decrease the size of a virtual object 460.

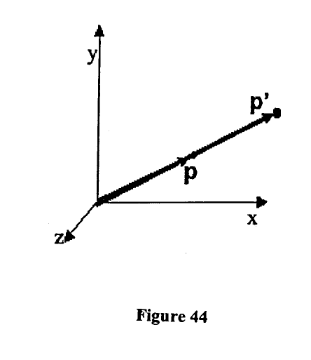

Referring to FIG. 44, each point p is placed sx times farther from the origin in the x-direction, etc. If a scale factor is negative, then there is also a reflection about a coordinate axis. This transformation is represented in (Equation 7):

$$S [ \begin{matrix}x \\ y \\ z \\ 1\end{matrix} ] = [ \begin{matrix}{s}_{x} x \\ {s}_{y} y \\ {s}_{z} z \\ 1\end{matrix} ] \\ S = [ \begin{matrix}{s}_{x} & 0 & 0 & 0 \\ 0 & {s}_{y} & 0 & 0 \\ 0 & 0 & {s}_{z} & 0 \\ 0 & 0 & 0 & 1\end{matrix} ] \qquad ( Equation 7 )$$

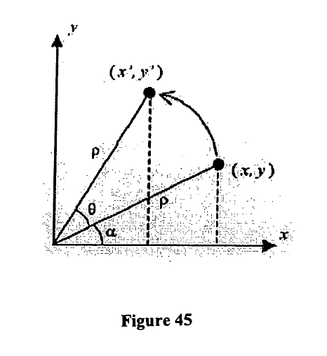

Referring to FIG. 45, rotation of a single point or vertex can be about the x-, y-, z-direction. Consider first rotating a point by θ about the origin in a 2D plane.

$$x = p cos α , y = p sin α ;$$

$${x}^{′} = p cos ( θ + α ) , {y}^{′} = p sin ( θ + α ) ;$$

$${x}^{′} = p ( cos θ cos α - sin θsin α ) == x cos θ - y sin θ \\ {y}^{′} = p ( sin θ cos α + cos θ sin α ) = x sin θ + y cos θ \\ [ \begin{matrix}{x}^{′} \\ {y}^{′} \\ 1\end{matrix} ] = [ \begin{matrix}cos θ & - sin θ & 0 \\ sin θ & cos θ & 0 \\ 0 & 0 & 1\end{matrix} ] [ \begin{matrix}x \\ y \\ 1\end{matrix} ]$$

when extended to 3D, rotation about Z-axis is represented by (Equation 8).

$$[ \begin{matrix}{x}^{′} \\ {y}^{′} \\ {z}^{′} \\ 1\end{matrix} ] = {R}_{z} [ \begin{matrix}x \\ y \\ z \\ 1\end{matrix} ] \\ {R}_{z} = [ \begin{matrix}cos θ & - sin θ & 0 & 0 \\ sin θ & cos θ & 0 & 0 \\ 0 & 0 & 1 & 0 \\ 0 & 0 & 0 & 1\end{matrix} ] \qquad ( Equation 8 )$$

Similarly for rotation about the x and y-axis are represented by (Equations 9 and 10) respectively:

$${R}_{x} = [ \begin{matrix}1 & 0 & 0 & 0 \\ 0 & cos θ & - sin θ & 0 \\ 0 & sin θ & cos θ & 0 \\ 0 & 0 & 0 & 1\end{matrix} ] \\ {R}_{y} = [ \begin{matrix}cos θ & 0 & sin θ & 0 \\ 0 & 1 & 0 & 0 \\ - sin θ & 0 & cos θ & 0 \\ 0 & 0 & 0 & 1\end{matrix} ] \qquad ( Equation 9 and 10 )$$

If a virtual object 460 undergoes translation, scaling or rotation before it is rendered in the final image 331, a new transformation matrix is created by multiplying sequences of the above basic transformations. Hence, the geometric pipeline transformation, M is represented by (Equation 11):

$$[ \begin{matrix}{x}^{′} \\ {y}^{′} \\ {z}^{′} \\ 1\end{matrix} ] = {R}_{z} {ST}_{r } {T}_{cm} [ \begin{matrix}x \\ y \\ z \\ 1\end{matrix} ]$$

where
   M=R_{z}ST_{y}T_{cm} (Equation 11)

Wireless Communication Module

The mobile phone module 340 communicates with the AR server module 341 via a wireless network. This allows flexibility and mobility to the user. Existing wireless transmission systems include Bluetooth, GPRS and Wi-Fi (IEEE 802.11b). Bluetooth is relatively easy to deploy and flexible to implement, in contrast to a GPRS network. Bluetooth is a low power, short-range radio technology. It is designed to support communications at distances between 10 to 100 metres for devices that operate using a limited amount of power.

To establish a Bluetooth connection with the mobile phone 311, the AR server module 341 uses a Bluetooth adaptor. A suitable adaptor is the TDK Bluetooth Adaptor. It has a range of up to 50 meters in free space and about 10 meters in a closed room. The profiles supported include GAP, SDAP, SPP, DUN, FTP, OBEX, FAX, L2CAP and RFCOMM. The Widcomm Bluetooth Software Development Kit is used to program the TDK USB Bluetooth adaptor in the Windows platform for the AR server module 341.

The Bluetooth protocol is a stacked protocol model where communication is divided into layers. The lower layers of the stack include the Radio Interface, Baseband, the Link Manager, the Host Control Interface (HCI) and the audio. The higher layers are the Bluetooth standardized part of the stack. These include the Logical Link Control and Adaptation Protocol (L2CAP), serial port emulator (RFCOMM), Service Discovery Protocol (SDP) and Object Exchange (OBEX) protocol.

The Baseband is responsible for channel encoding/decoding, low level timing control and management of the link within the domain of a single data packet transfer. The Link Manager in each Bluetooth module communicates with another Link Manager by using a peer-to-peer protocol called Link Manager Protocol (LMP). LMP messages have the highest priority for link-setup, security, control and power saving modes. The HCI-firmware implements HCI commands for the Bluetooth hardware by accessing Baseband commands, Link Manager commands, hardware status registers, control registers and event registers.

The L2CAP protocol uses channels to keep track of the origin and destination of data packets. A channel is a logical representation of the data flow between the L2CAP layers in remote devices. The RFCOMM protocol emulates the serial cable line settings and status of an RS-232 serial port. RFCOMM connects to the lower layers of the Bluetooth protocol stack through the L2CAP layer. By providing serial-port emulation, RFCOMM supports legacy serial-port applications. It also supports the OBEX protocol. The SDP protocol enables applications to discover which services are available and to determine the characteristic of those services using an existing L2CAP connection. After discovery, a connection is established using information obtained via SDP. The OBEX protocol is similar to the HTTP protocol and supports the transfer of simple objects, like files, between devices. It uses an RFCOMM channel for transport because of the similarities between IrDA (which defines the OBEX protocol) and serial-port communication.

There are three possible methods to transfer images 313, 331 between the mobile phone module 340 and AR server module 341.

Firstly, image data is saved into a JPEG file which is pushed as an object to the AR server 330. This method requires the OBEX protocol which sits on top of the RFCOMM protocol. This method is a high level implementation, has parity checking, a simple programming interface and has a lower data transfer rate compared to RFCOMM and L2CAP.

Secondly, image data is saved into a JPEG file and read back into memory. The binary data is then transferred to the server 330 or mobile phone 311 using RFCOMM protocol. This method is a high level implementation, has parity checking, the programming interface is slightly more complicated and has a lower data transfer rate compared to L2CAP.

Thirdly, image data is saved into a JPEG file and read back into memory. The binary data is then transferred to the server 330 or mobile phone 311 using L2CAP. This method is a low level implementation, has no parity checking, but checking only CRC in the baseband, has a complicated programming interface and has the highest data transfer rate.

The third method is preferred because it offers superior performance compared to the other two methods. Although there is no parity checking in L2CAP, CRC in the baseband is sufficient to detect errors in data transmission. The major constraint when using L2CAP is that it has a maximum packet size of 672 bytes. An image with 320×240 resolution has a size of 320×240×3=230400 bytes. Using JPEG compression, the average size is reduced to about 5000 to 15000 bytes. Given the constraints of L2CAP, the image is divided into packets smaller than 672 bytes in size and sent packet by packet. The module 340, 341 receiving these packets recombines the packets to form the whole image 313, 331.

The Bluetooth server in the AR server module 341 is created using the Widcomm Bluetooth development kit. The following steps are implemented:

1. Instantiate an object of class CL2CapIf and call function: CL2CapIf::AssignPsmValue( ) to get an Protocol Service Multiplexer (PSM) value.

2. Call CL2CapIf::Register( ) to register the PSM with the L2CAP layer.

3. Instantiate an object of class CsdpService and call the functions: AddServiceClassIdList, AddServiceName, AddL2CapProtocolDescriptor, MakePublicBrowseable to setup the service in the Bluetooth device.

4. Call CL2CapIf::SetSecurityLevel( )

5. CL2CapConn::Listen( ) starts the server, which then waits for a client to attempt a connection. The derived function: CL2CapConn::OnIncomingConnection( ) is called when an attempt is detected.

6. The server accepts the incoming connection by calling: CL2CapConn::Accept( ).

7. Data is sent using CL2CapConn::Write( ). The derived function: CL2CapConn: OnDataReceived( ) is called to receive incoming data.

8. The connection remains open until the server calls: CL2CapConn::Disconnect( ). The close can be initiated by the server or can be called in response to a CONNECT ERR event from the client.

The Bluetooth client in the mobile phone module 340 is created using UIQ SDK for Symbian OS v7.0. The following steps are implemented:

1. Instantiate an object derived from RSocket.

2. Call CQBTUISelectDialog::LaunchSingleSelectDialogLD( ) to launch a single dialog that performs a search for discoverable bluetooth devices and list them in the dialog.

3. SDP is ignored. Connection is done by choosing the “port”, which is the PSM value of the server. This will be discussed in Section 3.8

4. Call RSocket::Open( ) follow by RSocket::Connect( ) to begin the connection process.

5. Data is sent using RSocket::Write( ) and data is received from a remote host and completes when a passed buffer is full using RSocket::Read( )

The mobile phone module 340 initializes a Bluetooth client and capture images 313 using the camera. The Bluetooth client is written using Widcomm Development kit. The following steps are performed:

1. Inquiry of Bluetooth devices nearby.

2. Discovery of service using SDP.

3. Initiate L2CAP connection with AR server module 341.

4. Capture image 313 from the camera.

5. Resize image to 160×120 resolution.

6. Break raw image data into packets smaller than 672 bytes.

7. Send a packet of raw image data to the AR server module without compression.

8. Wait for confirmation from AR server module 341

9. Send the next packet of raw data image until all data in one image has finished.

For the AR server module 341, once all packets of raw data from an image 313 is received, the image 313 is reconstructed and tracking of fiducial marker 400 is performed. Once the marker 400 is detected, a virtual object 460 will be rendered with respect to the position of the marker 400 and the final image 331 is displayed on the screen. This process is repeated automatically in order to create a continuous video stream.

The discovery of services using SDP can be avoided by specifying the “port” of the PSM value in the AR server module 341 when the client 340 initiates a connection.

In this example, an image 313 of 160×120 resolution has a size of 160×120×s3=57600 bytes. This image 313 is divided into 87 packets with each packet having a size of 660 bytes. The packets are transmitted to the AR server module 341. Wireless video transmission via Bluetooth is at 0.4 fps with a transfer rate at about 20 to 30 kbps. Compression is necessary to improve the fps. Hence, JPEG compression is used to compress the image 313.

Integration is done by combining the image acquisition application on the mobile phone 311 with the Bluetooth client application 340. The marker tracking implemented is combined with the Bluetooth server application 341.

Applications

Two specific applications for the system are described. These applications are the AR Notes application and AR Catalogue.

Application 1: AR Notes Application

Conventional adhesive notes such as 3M Post-It® notes are commonly used in offices and homes. This system 310 combines the speed of traditional electronic messaging with the tangibility of paper based messages. In the AR Notes application, messages are location specific. In other words, the messages are displayed only when the intended receiver is within the relevant spatial context. This is done by deploying a number of fiducial markers 400 in different locations. Messages are posted remotely over the Internet and the sender can specify the intended recipient as well as the location of the message. The messages are stored in a server, and downloaded onto the phone 311 when the recipient uses their phone's digital camera to view a marker 400.

The AR Notes application enhances electronic messages by incorporating the element of location. Electronic messages such as SMS (Short Messaging System) are delivered to users irrespective of their location. Thus, important messages may be forgotten once new messages are received. Therefore it is important to have a messaging system that displays the message only when the recipient is present within the relevant spatial context. For example, a working mother can remind her child to drink his milk by posting a message on the fridge. The child will see the message only when he comes within the vicinity of the fridge. Since this message has been placed within its relevant spatial context, it is a more powerful reminder than a simple electronic message.

The AR Notes application provides:

1. Location based messaging: Messages delivered only in the appropriate location.

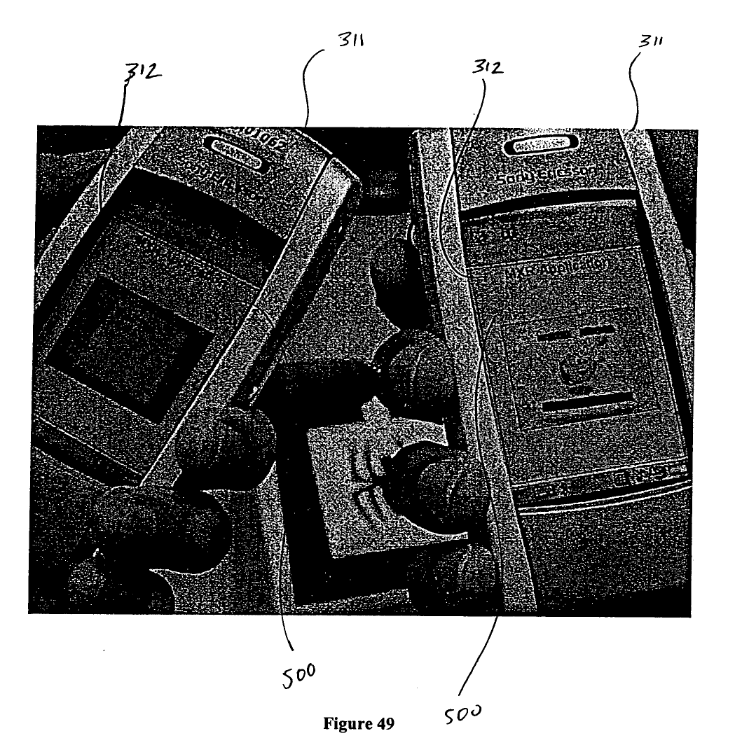

2. Privacy: Unlike paper Post-It® notes which can be seen by everyone, an AR Notes message will be visible only to the person to whom the message has been posted. Referring to FIG. 49, the two users see different messages even though they are viewing the same marker. One user gets the message “Boil the milk”, while the other user has received a picture of a smiley.

3. Remote Access: Messages can be posted remotely over the Internet.

4. 3D Display: Use of AR allows users to post 3D pictures of cartoon characters.

5. Neatness: Since the messages are electronic, the mess of paper is avoided.

Application 2: AR Catalogue Application

The AR Catalogue application aims to enhance the reading experience of consumers. 3D virtual objects are rendered into the actual scene captured by the mobile phone's 311 camera. These 3D objects are viewable from different perspectives allowing children to interact with them.

An AR catalogue is created by printing a collection of fiducial markers 400 in the form of a book. When a user of the AR phone system 310 captures an image of a page in the book containing a marker, the system 310 returns the appropriate virtual 3D object model. For example, a virtual toy catalogue is created by displaying a different 3D toy model on each page. Virtual toys are 3D which are more realistic to the viewer than flat 2D pictures.

The AR Catalogue aims to enhance the reading experience of consumers. While reading a story book about Kerropi the frog, children can use their mobile phones 311 to view a 3D image of Kerropi. The story book contains small markers onto which the virtual objects or virtual characters are rendered.

The AR Catalogue provides:

1. Full 3D display: The figures are in full 3D and the children can view these virtual objects from different sides.

2. Tangibility: The mobile phone serves as an aid for enhancing the narration of a story. Since it is small, it does not hinder the normal activities of the child.

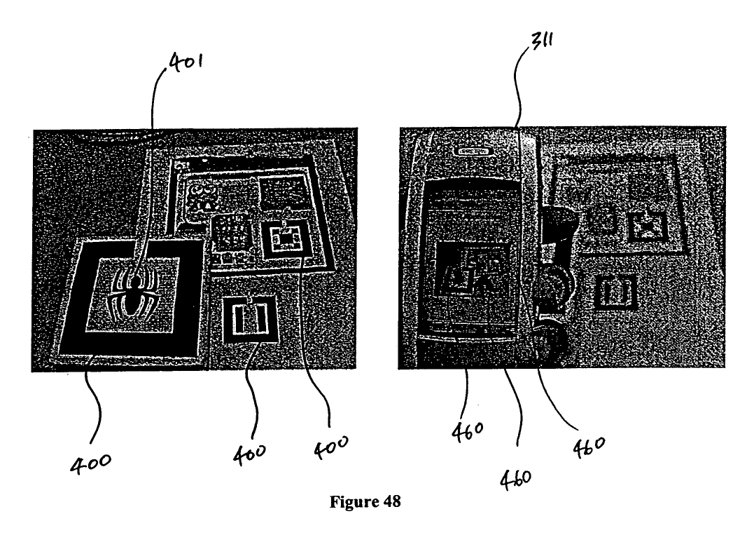

3. Multiple virtual object display: Multiple virtual objects can be displayed at the same time as illustrated in FIG. 48. FIG. 48 at (a) shows three markers placed side-by-side, FIG. 48 at (b) shows the enhanced AR image as viewed through the phone. As can be seen in FIG. 48 at (b), three virtual objects have been rendered into the scene.

The success rate of marker 400 tracking and pattern 401 recognition is dependent on the resolution of the image 313, the size of the fiducial marker 400 and the distance between the mobile phone 311 and the fiducial marker 400.

Some screenshots of the system 310 in use are described:

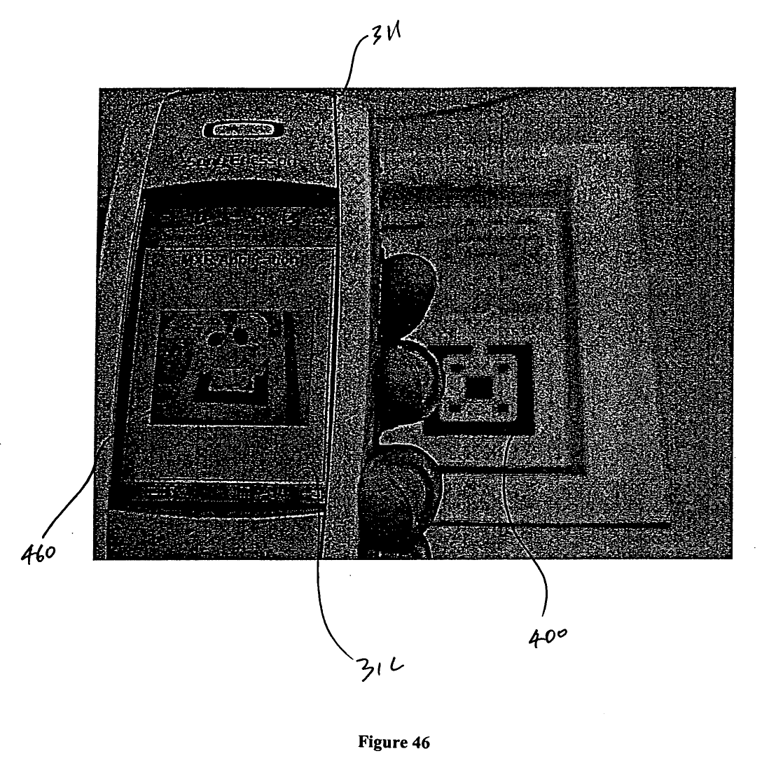

FIG. 46 shows an AR image of Kerropi the frog is displayed on the phone 311. The story book can be seen in the background.

FIG. 47 shows that the system 310 is able track two markers 400 and differentiate the pattern 401 of the markers 400. The left image shows the image 313 captured by the P800 311. The right image shows the final rendered image 331 displayed by the P800 311. The system 310 has successfully recognized the two different markers 400.

FIG. 48 shows that multiple markers 400 can be recognized at the same time. The left image shows the orientation of the markers 400. The right image shows the mobile phone 311 displaying three different virtual objects 460 in a relative position to the three markers 400.

FIG. 49 is a screenshot of the AR Notes application. Different messages are displayed when viewing the same marker 400. This has more privacy than traditional paper based Post-It® notes.

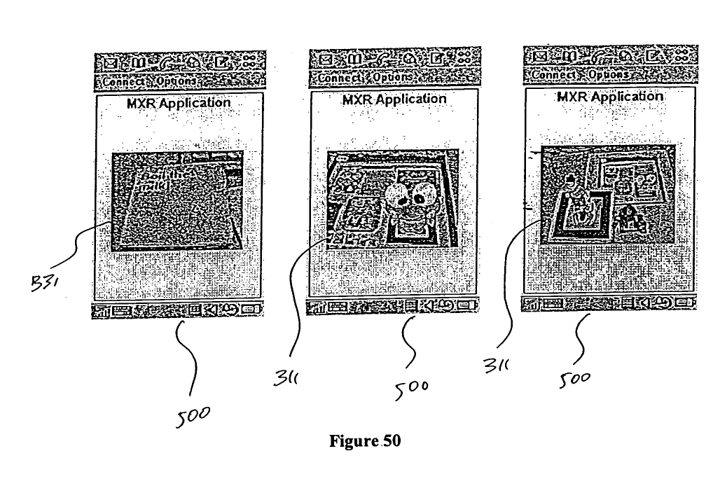

FIG. 50 shows screenshots of the MXR application displaying an augmented reality image 331, captured by the Sony Ericsson P800 mobile phone 311.

Server side processing can be avoided by having the phone 311 process and manipulate the images 313. Currently, most mobile phones are not designed for processor intensive tasks. But newer phones are being fitted with increased processing power. Another option is to move some parts of the MXR Toolkit 500 into the mobile phone module 340 such as the thresholding of images or detection of markers 400. This leads to less data being transmitted over Bluetooth and thus increases system performance and response times.

Data transfer over Bluetooth is relatively slow even after JPEG compression of the images. A 640×480×12 bit RGB image is around 80 to 150 Kb in size, depending on the level of compression. This is too large for a fast service request. Lowering the image resolution to 160×120×12 bit improves the performance but this affects the registration accuracy and pattern 401 recognition. Bluetooth has a theoretical maximum data rate of 723 kbps while the GPRS wireless network has a maximum of 171.2 kbps. However, the user does not experience the maximum transfer rate since those data rates assume no error correction.

Currently, 3G systems have a maximum data transfer rate of 384 Kbps. 3G is capable of reaching 2 Mbps. In addition, HSPDA offers data speeds up to 8 to 10 Mbps (and 20 Mbps for MIMO systems). Deploying the system onto a 3G network or other high speed networks will lead to improvements in performance. MMS messages can be used to transmit the images between the phone 311 and server 330.

Although Bluetooth has been described as the communication channel, other standards may be used such as 2.5G (GPRS), 3G, Wi-Fi IEEE 802.11b, WiMax, ZigBee, Ultrawideband, or Mobile-Fi.

Although the interactive system 210 has been programmed using Visual C++ 6.0 on the Microsoft Windows 2000 platform, other programming languages are possible and other platforms such as Linux and MacOS X may be used.

Although a Dragonfly camera 211 has been described, web cameras with at least 640×480 pixel video resolution may be used.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

1. A mobile platform for providing a mixed reality experience to a user via a mobile communications device of the user, the platform comprising:
an image capturing module to capture images of an item in a first scene, the item having at least one marker;
a communications module to transmit the captured images to a server, and to receive images in a second scene from the server providing a mixed reality experience to the user;
wherein the second scene is generated by retrieving multimedia content associated with an identified marker, and superimposing the associated multimedia content over the first scene in a relative position to the identified marker.

2. The platform according to claim 1, wherein the mobile communications device is a mobile phone, Personal Digital Assistant (PDA) or a PDA phone.

3. The platform according to claim 1, wherein the images are captured as still images or images which form a video stream.

4. The platform according to claim 1, wherein the item is a three dimensional object.

5. The platform according to claim 1, wherein the communications module communicates with the server via Bluetooth, 3G, GPRS, Wi-Fi IEEE 802.11b, WiMax, ZigBee, Ultrawideband, Mobile-Fi or any other wireless protocol.

6. The platform according to claim 5, wherein the images are communicated as data packets between the mobile communications device and the server.

7. The platform according to claim 1, wherein the image capturing module comprises an image adjusting tool to enable users to change the brightness, contrast and image resolution for capturing an image.

8. The platform according to claim 1, wherein the associated multimedia content are virtual objects.

9. The platform according to claim 8, wherein a maker is associated with more than one virtual object.

10. The platform according to claim 1, wherein the associated multimedia content is locally stored on the mobile communications device.

11. The platform according to claim 1, wherein the associated multimedia content is remotely stored on the server.

12. The platform according to claim 1, wherein the marker includes a discontinuous border that has a single gap.

13. The platform according to claim 12, wherein the marker comprises an image within the border.

14. The platform according to claim 13, wherein the image is a geometrical pattern.

15. The platform according to claim 14, wherein the pattern is matched to an exemplar stored in a repository of exemplars.

16. The platform according to claim 13, wherein the color of the border produces a high contrast to the background color of the marker, to enable the background to be separated by the server.

17. The platform according to claim 1, wherein the server is able to identify a marker if the border is partially occluded and if the pattern within the border is not occluded.

18. The platform according to claim 1, further comprising a display device to display the second scene at the same time the second scene is generated.

19. The platform according to claim 18, wherein the display device is a mobile phone screen, monitor, television screen or LCD.

20. The platform according to claim 19, wherein the video frame rate of the display device is in the range of twelve to thirty frames per second.

21. The platform according to claim 1, wherein multimedia content includes two dimensional or three dimensional images, video or audio information.

22. The platform according to claim 4, wherein at least two surfaces of the object are substantially planar.

23. The platform according to claim 22, wherein the at least two surfaces are joined together.

24. The platform according to claim 23, wherein the object is a cube or polyhedron.

25. The platform according to claim 1, wherein the image capturing module captures images using a camera.

26. The platform according to claim 25, wherein the camera is a CCD or CMOS video camera.

27. The platform according to claim 1, wherein the position of the item is calculated in three dimensional space.

28. The platform according to claim 27, wherein a positional relationship is estimated between the display device and the object.

29. The platform according to claim 1, wherein the captured image is thresholded.

30. The platform according to claim 29, wherein contiguous dark areas are identified using a connected components algorithm.

31. The platform according to claim 30, wherein a contour seeking technique is used to identify the outline of these dark areas.

32. The platform according to claim 31, wherein contours that do not contain four corners are discarded.

33. The platform according to claim 31, wherein contours that contain an area of the wrong size are discarded.

34. The platform according to claim 31, wherein straight lines are fitted to each side of a square contour.

35. The platform according to claim 34, wherein the intersections of the straight lines are used as estimates of corner positions.

36. The platform according to claim 35, wherein a projective transformation is used to warp the region described by the corner positions to a standard shape.

37. The platform according to claim 36, wherein the standard shape is cross-correlated with stored exemplars of markers to identify the marker and determine the orientation of the object.

38. The platform according to claim 35, wherein the corner positions are used to identify a unique Euclidean transformation matrix relating to the position of a display device displaying the second scene to the position of the marker.

39. A mobile platform for providing a mixed reality experience to a user via a mobile communications device of the user, the platform comprising:
an image capturing module to capture images of an item in a first scene, the item having at least one marker; and
a graphics module to retrieve multimedia content associated with an identified marker, and generate a second scene including the associated multimedia content superimposed over the first scene in a relative position to the identified marker, to provide a mixed reality experience to the user.

40. A server for providing a mixed reality experience to a user via a mobile communications device of the user, the server comprising:
a communications module to receive captured images of an item in a first scene from the mobile communications device, and to transmit images in a second scene to the mobile communications device providing a mixed reality experience to the user, the item having at least one marker; and
an image processing module to retrieve multimedia content associated with an identified marker, and to generate the second scene including the associated multimedia content superimposed over the first scene in a relative position to the identified marker.

41. A system for providing a mixed reality experience to a user via a mobile communications device of the user, the system comprising:
an item having at least one marker;
an image capturing module to capture images of the item in a first scene;
an image display module to display images in a second scene providing a mixed reality experience to the user;
wherein the second scene is generated by retrieving multimedia content associated with an identified marker, and superimposing the associated multimedia content over the first scene in a relative position to the identified marker.

42. A method for providing a mixed reality experience to a user via a mobile communications device of the user, the method comprising:
capturing images of an item having at least one marker, in a first scene;
displaying images in a second scene to provide a mixed reality experience to the user;
wherein the second scene is generated by retrieving multimedia content associated with an identified marker, and superimposing the associated multimedia content over the first scene in a relative position to the identified marker.

43. A mixed reality application for delivering messages to a user via a mobile communications device of the user, the application comprising:
an item having at least one marker;
an image capturing module to capture images of the item in a first scene;
an image display module to display images in a second scene providing a mixed reality experience to the user;
wherein the second scene is generated by retrieving a message associated with an identified marker, and superimposing the message over the first scene in a relative position to the identified marker.

44. The application according to claim 43, wherein the message is a reminder, e-mail, calendar entry or task to perform.

45. The application according to claim 43, wherein the item is magnetic or adhesive, to enable the item to be positioned on a refrigerator door or wall, respectively.

46. A mixed reality application for reading via a mobile communications device of a user, the application comprising:
a book having at least one marker on each page;
an image capturing module to capture images of at least one page in a first scene;
an image display module to display images in a second scene providing a mixed reality experience to the user;
wherein the second scene is generated by retrieving multimedia content associated with an identified marker, and superimposing the associated multimedia content over the first scene in a relative position to the identified marker.

47. The application according to claim 46, wherein the book is a catalogue.

48. The platform according to claim 5, where if communication between the mobile communications device and the server is via Bluetooth, a Logical Link Control and Adaptation Protocol (L2CAP) service is initialized.

49. The platform according to claim 48, wherein the mobile communications device discovers a server for providing a mixed reality experience to a user by searching for Bluetooth devices within the vicinity of the mobile communications device.

50. The platform according to claim 1, wherein the captured image is resized to 160×120 pixels.

51. The platform according to claim 50, wherein the resized image is compressed using the JPEG compression algorithm.

52. The platform according to claim 1, wherein the marker is unoccluded to identify the marker.

53. The platform according to claim 1, wherein the marker is a predetermined shape.

54. The platform according to claim 53, wherein at least a portion of the shape is recognized by the server to identify the marker.

55. The platform according to claim 54, the server determines the complete predetermined shape of the marker using the recognized portion of the shape.

56. The platform according to claim 55, wherein the predetermined shape is a square.

57. The platform according to claim 56, wherein the server determines that the shape is a square if one corner of the square is occluded.
